(19) United States
(12) Patent Application Publication
(10) Pub. No.: US 2025/0101662 A1
(43) Pub. Date: Mar. 27, 2025

(54) CLOTHING TREATMENT APPARATUS

(71) Applicant: LG Electronics Inc., Seoul (KR)

(72) Inventors: Taejun YOON, Seoul (KR); Hyunggyu LIM, Seoul (KR); Hyungha KANG, Seoul (KR); Jaehyung KIM, Seoul (KR); Semin JANG, Seoul (KR); Wansik NAM, Seoul (KR); Jongsung KIM, Seoul (KR); Juhui KIM, Seoul (KR)

(21) Appl. No.: 18/833,781

(22) PCT Filed: Jan. 27, 2023
(86) PCT No.: PCT/KR2023/001247

§ 371 Date: Jul. 26, 2024

(30) Foreign Application Priority Data
Jan. 28, 2022 (KR) 10-2022-0012835
Jan. 28, 2022 (KR) 10-2022-0012838
Jan. 28, 2022 (KR) 10-2022-0012847
Jan. 28, 2022 (KR) 10-2022-0012869
Jan. 28, 2022 (KR) 10-2022-0012873
Jan. 28, 2022 (KR) 10-2022-0012885
Jan. 27, 2023 (KR) 10-2023-0010753

(51) Int. Cl. D06F 39/08; D06F 39/14

(52) U.S. Cl. CPC D06F 39/08; D06F 39/14

(57) ABSTRACT

The present invention relates to a clothing treating apparatus comprising at least one water pail that is detachably provided at the front of a machine room to provide water for generating steam to the inside of the machine room or to collect water condensed in the machine room, the water pail comprising: a storage body which has an opening on the upper portion and accommodates water; and a cover portion which is detachably provided on the storage body and closes the opening, wherein the cross-sectional area of the opening corresponds to the cross-sectional area of the storage body.

### TECHNICAL FIELD

The present disclosure relates to a clothing treatment apparatus, and more particularly to a clothing treatment apparatus capable of supplying steam and hot air to laundry to perform a refresh procedure such as sterilization, removal of wrinkles, deodorizing and drying of the laundry.

### BACKGROUND ART

Generally, a clothing treatment apparatus conceptually includes a washing machine configured to wet laundry with water and then to remove foreign matter from the wet laundry through chemical action of detergent and physical action such as rotation of a drum, and a dryer configured to dry the wet laundry using hot air and steam.

Recently, a laundry manager, which is designed to maintain dried laundry in the comfort and clean state while not being wet with water, has been developed. This kind of laundry manager is able to perform a refresh procedure of deodorizing, drying or sterilizing laundry by supplying steam or hot air in the state in which the laundry is supported.

The laundry manager is designed to selectively provide fragrance to laundry. Recently, such a clothing treatment apparatus has been considered as an important apparatus together with a washer and a dryer among various clothing treatment apparatuses.

Because the laundry manager, which is configured to perform a refresh procedure, receives laundry in dried state, it is essential to include a steam supplier configured to supply steam to laundry.

As conventional clothing treatment apparatuses, Korea unexamined patent publications Nos. 10-2020-0057545 and 10-2011-0067832 and the like may be suggested.

Each of the clothing treatment apparatuses includes a water supply container configured to supply steam to laundry, and a water discharge container configured to condense the water evaporated from laundry and to discharge the condensed water.

The water supply container and the water discharge container may be detachably coupled to the machine compartment of the clothing treatment apparatus, and may be freely installed even when the clothing treatment apparatus is spaced apart from a water supply source.

However, because the water supply container and the water discharge container store water therein and are disposed in the clothing treatment apparatus, there is the concern of propagation of bacteria and the like. Furthermore, because each of the water supply container and the water discharge container includes an opening portion which communicates with the inside thereof and has a cross-sectional area significantly smaller than the cross-sectional area of each of the water supply container and the water discharge container, there is a problem in that it is difficult to wash the water supply container and the water discharge container.

Meanwhile, the conventional clothing treatment apparatus includes a stopper (or a coupling device) which is reciprocated by means of a spring so as to detachably couple the water supply container and the water discharge container to the machine compartment or the cover. Here, the stopper has a length corresponding to the length of the spring in order to support compression and expansion of the spring at the regular position.

Therefore, there is a problem in that the volume of the water supply container and the water discharge container are reduced and the areas of the opening portions of the water supply container and the water discharge container are further reduced due to the stopper. Particularly, when the stopper includes a pair of stoppers which are disposed at opposite lateral sides of the water supply container or the water discharge container, there is a problem in that the area of the opening portion is further reduced.

In the conventional clothing treatment apparatus, a construction configured to close the opening portion of the water supply container or the water discharge container or to be coupled to the opening portion and a construction configured to fix the water supply container and the water discharge container to the machine compartment are different from each other. Accordingly, there is a problem in that the structures of the water supply container and the water discharge container are very complicated.

Furthermore, because a user could not intuitively recognize the water levels in the water supply container and the water discharge container of the conventional clothing treatment apparatus, there is a problem in that there is no other choice but to directly grip the water supply container and the water discharge container or to rely on notification from the clothing treatment apparatus.

In addition, because the conventional clothing treatment apparatus is unable to reliably seal the opening portion of the water supply container or the water discharge container when the opening portion is enlarged, there is a fundamental problem in that the area of the opening portion cannot be enlarged.

### DISCLOSURE

### Technical Task

An object to be solved according to the present disclosure is to provide a clothing treatment apparatus capable of reducing the volume or length of a stopper or a coupler capable of detachably fixing a water storage to a machine compartment.

Another object to be solved according to the present disclosure is to provide a clothing treatment apparatus capable of easily performing all of washing, disinfection, sterilization, water introduction and water discharge by maximally enlarging an opening portion which is detachably coupled to a machine compartment.

Still another object to be solved according to the present disclosure is to provide a clothing treatment apparatus to provide a clothing treatment apparatus equipped with a water storage capable of preventing leaking and outflow of water through an opening portion.

Yet another object to be solved according to the present disclosure is to provide a clothing treatment apparatus which enables a user to intuitively check the water level in a water storage by radiating light to the water storage.

Still yet another object to be solved according to the present disclosure is to provide a clothing treatment apparatus equipped with a water storage and an attachment which are capable of being easily manufactured through a metal mold.

### Technical Solutions

In order to solve above-mentioned objects, the present disclosure provides a clothing treatment apparatus including a cabinet having an opening at a front surface thereof, an inner case provided in the cabinet and defining a accommodation space configured to receive laundry, a machine compartment disposed lower than the inner case so as to supply at least one of hot air and steam to an inside of the inner case, a door rotatably coupled to the cabinet so as to close at least one of the inner case and the machine compartment, and a water storage detachably provided in front of the machine compartment so as to supply water for generation of steam to an inside of the machine compartment or to collect water condensed in the machine compartment.

The water storage may include a storage body including an opening portion at an upper portion thereof and receiving water therein and a cover detachably coupled to the storage body so as to close the opening portion, and the cross-sectional area of the opening portion may correspond to a cross-sectional area of the storage body.

The opening portion may be configured to open an entire upper portion of the storage body, and the cover may be configured to entirely close the opening portion.

The cover may include a cover body introduced into the opening portion and detachably coupled to an inner surface of the storage body and an introduction hole formed through the cover body so as to communicate with an inside of the storage body.

The water storage may further include a seal coupled to the cover body along a periphery of the cover body so as to come into contact with an inner surface of the storage body.

The water storage may include a stopper which projects from the cover body and is detachably coupled to the storage body, and the stopper may be disposed higher than the seal.

The stopper may include a pair of stoppers which are inserted into the cover body from two lateral sides of the cover body so as to be separated from the storage body.

The clothing treatment apparatus may further include a handle coupled to an upper portion of the cover so as to close the introduction hole.

The handle may include a main body seated on an upper portion of the cover body, a handle body projecting forwards from a front and upper portion of the handle body, and a support body obliquely extending from a front and lower portion of the handle body.

The support body may be disposed in front of the stopper.

The handle may further include a grip portion coupled to a front side of the handle body and projecting downwards beyond the handle body.

The handle may further include a communication hole formed through an upper portion of the handle body so as to communicate with the opening portion, and a cover door rotatably coupled to the upper portion of the handle body so as to close the communication hole.

The communication hole may be formed through an upper portion of the handle from a portion behind the stopper to a portion ahead of the stopper, and the cover door may be coupled to a portion of the handle body behind the stopper in such a manner as to be rotated upwards so as to selectively open the communication hole.

The storage body may include open surfaces provided at upper portions of two lateral surfaces of the storage body so as to face the main body, and sloped surfaces which extend downwards from front sides of the open surfaces to face the support body.

The storage body may further include coupling holes which are formed through two lateral sides of the storage body and into which the stoppers are inserted, and the coupling holes may be disposed behind the sloped surface.

The storage body may be made of a translucent or transparent material.

In order to solve above-mentioned objects, the present disclosure provides a clothing treatment apparatus including a cabinet having an opening at a front surface thereof, an inner case provided in the cabinet and defining a accommodation space configured to receive laundry, a machine compartment disposed lower than the inner case so as to supply at least one of hot air and steam to an inside of the inner case, a door rotatably coupled to the cabinet so as to close at least one of the inner case and the machine compartment, and at least one water storage seated in front of the machine compartment so as to supply water for generation of steam to an inside of the machine compartment or to collect water condensed in the machine compartment.

The machine compartment may include an attachment in front thereof in which the water storage is detachably received.

The water storage may include a storage body including an opening portion at an upper portion thereof and receiving water therein, a cover detachably coupled to the storage body so as to close the opening portion, stoppers detachably coupled to the attachment so as to project from the cover, and an elastic portion configured to project the stopper from the cover.

The cover may include a cover body coupled to the storage body so as to close the opening portion, installation grooves provided at two opposite lateral sides of the cover body so as to receive the stopper therein, and exposure holes formed through two opposite surfaces of the cover body so as to allow the stoppers to project therethrough.

Each of the stoppers may include a fixing button which projects from the exposure hole and is coupled to the attachment, and an elastic fixing portion which extends from the fixing button to fix the elastic portion.

The elastic fixing portion may have a length less than the length of the elastic portion and may extend from the fixing button.

Each of the installation grooves may include an elastic support groove in which the elastic portion is seated, and a button movement groove which extends to the exposure hole from the elastic support groove.

The clothing treatment apparatus may further include a handle which is coupled to the upper portion of the cover so as to support the load of the water storage.

The handle may include a fixing rib which is inserted into the installation groove so as to fix the elastic portion.

The handle may further include a restricting protrusion which is spaced apart from the fixing rib toward the exposure hole and prevents separation of the fixing button.

The length of the restricting protrusion may be less than the length of the fixing rib.

The stopper may further include a restricting portion which is disposed between the fixing button and the elastic restoring portion so as to contact the restricting protrusion and has a larger surface area than the fixing button.

The stopper may further include a movement guide which extends from the restricting portion to guide a direction in which the fixing button reciprocates.

The cover may further include a projection stopper which is provided between the projection hole and the restricting protrusion so as to restrict projection of the fixing button.

The cover may further include a guide rail which extends toward the elastic support groove from the projection hole in the installation groove to guide movement of the fixing button.

The cover may further include an insertion stopper which is disposed at a position farther than the projection hole from the projection stopper so as to restrict insertion of the fixing button.

The cover may include a support rib which projects from the elastic support groove to support the free end of the elastic portion.

The fixing button may further include a fixing insertion surface which is detachably inserted into the attachment, and a fixing sloping surface which obliquely extends toward the fixing support from the fixing insertion surface.

The fixing sloping surface may extend from the lower portion of the fixing insertion surface.

In order to solve above-mentioned objects, the present disclosure provides a clothing treatment apparatus including a cabinet having an opening at a front surface thereof, an inner case provided in the cabinet and defining a accommodation space configured to receive laundry, a machine compartment disposed lower than the inner case so as to supply at least one of hot air and steam to an inside of the inner case, a door rotatably coupled to the cabinet so as to close at least one of the inner case and the machine compartment, and at least one water storage seated in front of the machine compartment so as to supply water for generation of steam to an inside of the machine compartment or to collect water condensed in the machine compartment.

The water storage may include a storage body including an opening portion at an upper portion thereof and receiving water therein and a cover detachably coupled to the storage body so as to close the opening portion.

The storage body may be constructed such that the cross-sectional area thereof gradually decreases moving downwards from the opening portion.

The two lateral surfaces of the storage body may extend such that the distance between the two lateral surfaces gradually decreases moving downwards from the opening portion.

The width of the storage body may gradually decrease moving backwards from the front.

The storage body may be constructed such that the distance between the two lateral surfaces thereof gradually decreases moving toward the rear surface from the front surface of the storage body.

The machine compartment may include an attachment which is provided in front of the machine compartment and in which a plurality of water storages are detachably received.

The attachment may include a central separator disposed between the plurality of water storages.

The central separator may be constructed such that the thickness thereof gradually increases moving backwards from the front.

The water storage may further include a plurality of stoppers which are capable of projecting from the cover and are detachably coupled to the attachment.

At least some of the plurality of stoppers may be detachably coupled to the central separator.

The central separator may further include an installation groove which is depressed from an exposed surface thereof and into which the stoppers are detachably inserted.

The depth of the installation groove may gradually increase moving backwards from the front.

The water storage may include a water level sensor which is installed in the storage body so as to sense the water level in the storage body, and a sensor case which extends from the storage body and in which the water level sensor is received.

The sensor case may include an opening through which the water level sensor is inserted. The opening may be oriented so as to face toward the central separator.

The water storage may include a water supply container configured to store water to be supplied to the machine compartment, and a water discharge container configured to collect the water discharged from the machine compartment.

The water level sensor may include a water supply sensor configured to sense the water level in the water supply container, and a water discharge sensor configured to sense the water level in the water discharge container.

The sensor case may include a water supply sensor case which has a water supply sensor insertion opening formed in one side thereof through which the water supply sensor is inserted, and a water supply sensor case which has a water discharge sensor insertion opening formed in one side thereof through which the water supply sensor is inserted.

The water supply sensor insertion opening and the water discharge sensor insertion opening may be disposed so as to face each other.

The water supply sensor case may be disposed in the water supply container at a biased position far away from the water discharge container in the width direction.

The water discharge sensor case may be disposed in the water discharge container at a biased position far away from the water supply container in the width direction.

The water supply sensor case may be disposed higher than the water discharge sensor case.

The water supply container may include a water discharge outlet formed in the lower portion thereof through which water is discharged, and the water discharge container may include a water discharge outlet formed in the rear surface thereof through which water is introduced.

In order to solve above-mentioned objects, the present disclosure provides a clothing treatment apparatus including a cabinet having an opening at a front surface thereof, an inner case provided in the cabinet and defining a accommodation space configured to receive laundry, a machine compartment disposed lower than the inner case so as to supply at least one of hot air and steam to an inside of the inner case, a door rotatably coupled to the cabinet so as to close at least one of the inner case and the machine compartment, and at least one water storage seated in front of the machine compartment so as to supply water for generation of steam to an inside of the machine compartment or to collect water condensed in the machine compartment.

The water storage may include a storage body including an opening portion at an upper portion thereof and receiving water therein, a cover detachably coupled to the storage body so as to close the opening portion, and a seal coupled to the cover so as to seal the opening portion.

The cover may include a cover body, at least a portion of which is inserted into the storage body, and a seating surface which is depressed along the periphery of the cover body and in which the seal is installed.

The seal may include a sealing body seated on the seating surface, and a contact ring which projects from the sealing body to come into contact with the inner surface of the storage body.

The contact ring may include a plurality of contact rings which are disposed in the state of being spaced apart from each other in the thickness direction of the sealing body.

The water storage may further include a stopper which is capable of projecting from the cover and of being detachably coupled to the storage body. The seal may be disposed lower than the stopper.

The seal may be disposed lower than the opening portion.

The storage body may include two lateral surfaces defining the lateral surfaces of the opening portion, and stepped surfaces which extend downwards to a lower position from the two lateral surfaces.

The seal may be disposed lower than the stepped surfaces.

In order to solve above-mentioned objects, the present disclosure provides a clothing treatment apparatus including a cabinet having an opening at a front surface thereof, an inner case provided in the cabinet and defining a accommodation space configured to receive laundry, a machine compartment disposed lower than the inner case so as to supply at least one of hot air and steam to an inside of the inner case, a door rotatably coupled to the cabinet so as to close at least one of the inner case and the machine compartment, and at least one water storage seated in front of the machine compartment so as to supply water for generation of steam to an inside of the machine compartment or to collect water condensed in the machine compartment.

The machine compartment may include an attachment in front thereof in which the water storage is detachably received, and an illuminator which is coupled to the attachment and radiates light to the water storage.

At least a portion of the water storage may be made of a translucent or transparent material through which light is transmitted.

The attachment may include a reception body configured to shield the front side of the machine compartment, and a reception groove depressed from the reception body so as to receive the water storage therein.

The illuminator may be disposed on the upper surface of the reception groove.

The water storage may include a storage body which is seated in the reception groove, includes an opening portion formed at the upper portion thereof, and receives water therein, and a cover detachably coupled to the storage body so as to close the opening portion.

The cover may include an introduction hole configured to guide the light to the inside of the storage body.

The water storage may further include a cover door configured to close the introduction hole.

The cover door may be made of a translucent or transparent material.

The storage body may be made of a translucent or transparent material.

The water storage may include a stopper which projects from the cover body and is detachably coupled to the storage body.

The illuminator may be disposed behind the stopper.

### Advantageous Effects

The present disclosure has an effect of reducing the volume or length of the stopper or the coupler configured to detachably fix the water storage to the machine compartment.

The present disclosure has an effect of easily performing all of washing, disinfection, sterilization, water introduction, and water discharge by maximally enlarging the opening portion of the water storage configured to be detachably coupled to the machine compartment.

The present disclosure has an effect of providing the water storage capable of preventing leakage and outflow of water through the opening portion.

The present disclosure has an effect of enabling a user to intuitively check the water level in the water storage by radiating light to the water storage.

The present disclosure has an effect of easily manufacturing the water storage and the attachment using a metal mold.

### DESCRIPTION OF DRAWINGS

FIG. 1 illustrates the appearance of the clothing treatment apparatus 1 according to the present disclosure;

FIG. 2 illustrates the structure of the machine compartment of the laundry treatment according to the present disclosure;

FIG. 3 illustrates the structure of the base of the machine compartment of the clothing treatment apparatus according to the present disclosure;

FIG. 4 illustrates the arrangement of the circulation duct and the heat supply of the clothing treatment apparatus according to the present disclosure;

FIG. 5 illustrates the structure of the base cover of the clothing treatment apparatus according to the present disclosure;

FIG. 6 illustrates the installed structure of the steam supply;

FIG. 7 illustrates the detailed structure of the steam supply;

FIG. 8 illustrates the interior of the steam generator;

FIG. 9 illustrates the structure of the water storage of the clothing treatment apparatus according to the present disclosure;

FIG. 10 illustrates the structure in which the water storage of the clothing treatment apparatus according to the present disclosure is detachably coupled to the attachment;

FIG. 11 illustrates an example of the structure of the water storage;

FIG. 12 illustrates an example of the detailed structure of the storage body;

FIG. 13 illustrates the structure in which the handle communicates with the inside of the storage body;

FIG. 14 illustrates an example of the structure configured to open and close the opening portion;

FIG. 15 illustrates a detailed example of the handle part 430;

FIG. 16 illustrates an example of the stopper;

FIG. 17 illustrates the structure configured to support the stopper;

FIG. 18 illustrates an additional example in which the handle and the cover guide the stopper and the elastic portion;

FIG. 19 illustrates an example of the shape of the storage body;

FIG. 20 illustrates an example of the attachment 380;

FIG. 21 illustrates an example of the coupling groove;

FIG. 22 illustrates the interior of the storage body;

FIG. 23 illustrates the sealing structure of the water storage;

FIG. 24 illustrates the detailed structure of the seal;

FIG. 25 illustrates an additional example of the attachment; and

FIG. 26 illustrates an aspect in which the illuminator radiates light.

### BEST MODE FOR DISCLOSURE

Hereinafter, embodiments disclosed in this specification will be described in detail with reference to the accompanying drawings. In this specification, the same or equivalent components may be denoted by the same reference numbers even in different drawings, and a description thereof will not be repeated. Singular forms as used herein are intended to include plural forms as well, unless the context clearly indicates otherwise. Furthermore, in the following description of embodiments disclosed herein, if it is decided that a detailed description of known functions or configurations related to the present disclosure would make the subject matter of the present disclosure unclear, such detailed description is omitted. The accompanying drawings are used merely to assist in easy understanding of various technical features, and it should be understood that the technical idea presented in this specification should not be construed as being limited by the accompanying drawings.

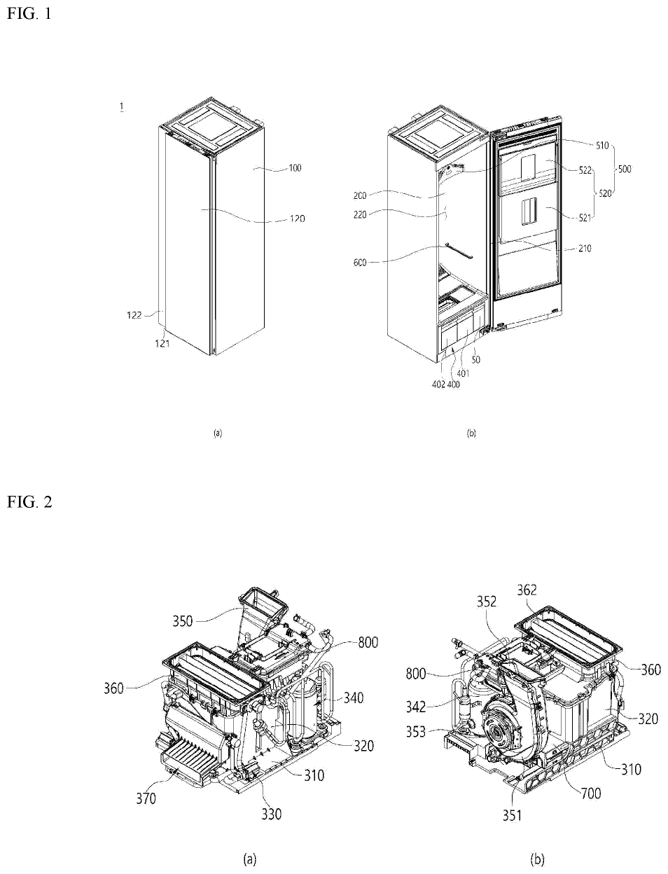

FIG. 1 illustrates the appearance of the clothing treatment apparatus 1 according to the present disclosure.

Referring to FIG. 1(a), the clothing treatment apparatus according to the present disclosure may include a cabinet 100 defining the appearance of the apparatus and a door 120 rotatably coupled to the cabinet 100.

The door 120 may include a main body 121 defining the front surface of the cabinet 100 and an installation body 122 which extends from one side of the main body 121 and on which a display configured to display information on the clothing treatment apparatus is mounted.

The installation body 122 may be constructed so as to form a stepped portion which extends in the backward direction of the cabinet 100 from the main body 121.

At least a portion of the installation body 122 may be disposed behind the main body 121 so as to overlap the main body 121 in the forward/backward direction. Consequently, the installation body 122 may serve as a handle.

The installation body 122 may be constructed so as to have a material or color different from the main body 122. Furthermore, the installation body 122 may be made of a semitransparent material which allows the light emitted from the display to be transmitted therethrough.

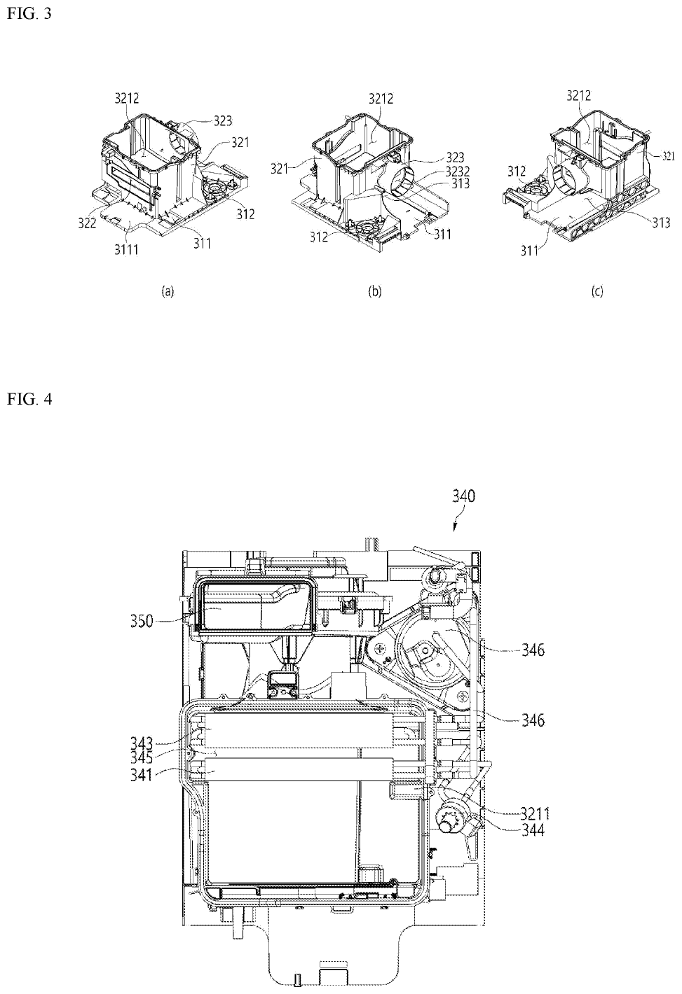

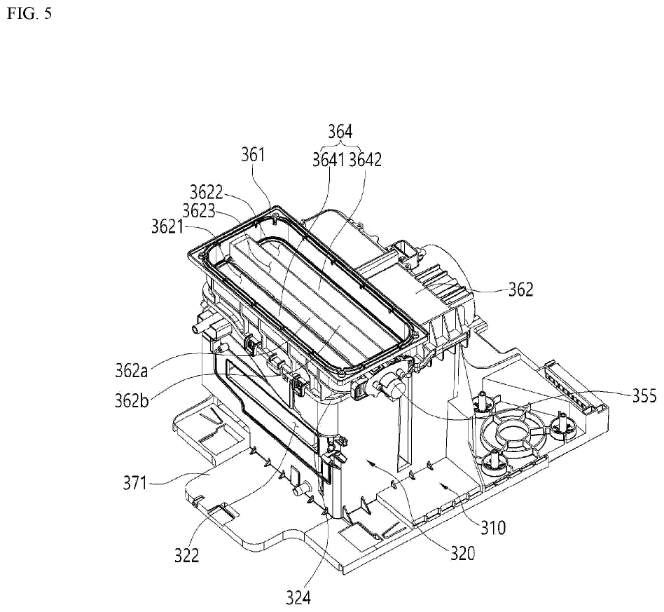

Referring to FIG. 3(b), the cabinet 100 may be provided therein with an inner case 200 having a accommodation space 220 configured to receive laundry therein. The inner case 200 may include an opening 210 through which laundry is introduced into and taken out of the inner case 200, and the opening 210 may be closed by the door 120.

The inner case 200 may be made of plastic resin, more particularly, reinforced plastic resin which is not deformed even by air having a temperature higher than ambient air or heated air (referred to hereinafter as “hot air”) and steam or moisture.

A width of the inner case 200 may be greater than a width thereof. As a result, laundry may be received in the accommodation space 220 in the state of being neither folded nor crumpled.

The clothing treatment apparatus 1 according to the present disclosure may include a storage compartment 500 which enables laundry to be kept in the accommodation space 220 in the inner case 200.

The storage compartment 500 may include a hanging portion 510 which is provided on the upper surface of the inner case 200 so as to allow laundry to be hung thereon.

When laundry is hung on the hanging portion 510, the laundry may be disposed in the accommodation space 220 in the state of being suspended in midair.

The storage compartment 500 may further include a pressing portion 520 which is coupled to the inner surface of the door 120 to hold laundry.

The hanging portion 510 may be constructed so as to have a bar shape which is disposed in the width direction of the inner case 200 to allow laundry hangers including laundry hung thereon to be supported thereby. Furthermore, the hanging portion 510 may be constructed so as to have the shape of a laundry hanger to allow laundry to be directly hung thereon, as illustrated in the drawing.

The clothing treatment apparatus according to the present disclosure may further include a vibration applicator configured to vibrate the hanging portion 510 to remove foreign matter such as fine dust from laundry.

The storage compartment 500 may include a pressing portion 520 which is provided at the door 120 to press and hold laundry. The pressing portion 520 may include a support 522, which is fixed to the inner surface of the door 120 so as to support one side of laundry, and a presser 521 configured to press the laundry supported by the support 522.

The presser 521 may be configured so as to move toward and away from the support 522. For example, the presser 521 may be rotatably provided on the inner surface of the support 522 or the door 120.

Consequently, the presser 521 and the support 522 are able to remove wrinkles from laundry or to create creases in the laundry by pressing opposite sides of the laundry.

The clothing treatment apparatus according to the present disclosure may include a machine compartment 300 in which are installed various kinds of devices capable of supplying one or more of hot air and steam to the accommodation space 220 or of purifying or dehumidifying external air of the cabinet 100.

The machine compartment 300 may be disposed so as to be separated or partitioned from the inner case 200 in the state of being in communication with the inner case 200.

The machine compartment 300 may be disposed below the inner case 200. Consequently, when hot air and steam, which has a low specific gravity, is supplied to the inner case 200, the hot air and the steam may be naturally supplied to the laundry.

The machine compartment 300 may include a heat supply 340 capable of supplying hot air to the inside of the inner case 200. The heat supply 340 may be embodied as a heat pump system, or may be embodied as a heater configured to directly heat air using electrical energy.

When the heat supply 340 is embodied as a heat pump system, the heat supply 340 may be configured to dehumidify and heat the air discharged from the inner case 200 and then to supply the air to the inner case 200. A detailed description thereof will be given later.

The machine compartment 300 may include a steam supply 800 capable of supplying steam to the inside of the inner case 200. The steam supply 800 may be configured to directly supply steam to the inside of the inner case 200. A detailed description thereof will be given later.

To this end, the inner case 200 may include a plurality of through holes 230, which are formed through one surface of the inner case 200 so as to communicate with the machine compartment 300.

By means of the through holes 230, the air in the accommodation space 220 may be supplied to the machine compartment 300, and one or more of hot air and steam created in the machine compartment 300 may be supplied to the accommodation space 220.

The through holes 230 may include an introduction hole 231, which is formed through the lower surface of the inner case 200 so as to allow the air in the inner case 200 to be discharged or sucked into the machine compartment 300, and a discharge hole 232, which is formed through the lower surface of the inner case 200 so as to allow the hot air created in the machine compartment 300 to be discharged therethrough.

The discharge hole 232 may be disposed at the lower surface of the inner case 200 near the rear surface of the inner case 200. For example, the discharge hole 232 may be obliquely disposed with respect to the ground between the lower surface and the rear surface of the inner case 200 so as to be directed toward the hanging portion 510.

The introduction hole 231 may be disposed at the lower surface of the inner case 200 near the front surface of the inner case 200. Consequently, the introduction hole 231 may be spaced apart from the discharge hole 232.

The through holes 230 may include a steam hole 233 through which the steam created in the steam supply 800 is supplied. The steam hole 233 may be disposed at one side of the discharge hole 232.

The clothing treatment apparatus according to the present disclosure may include at least one water storage 400 which is detachably mounted at the front side of the machine compartment so as to supply water for generation of steam to the inside of the machine compartment or to collect the water condensed in the machine compartment.

The water storage 400 may include a water supply container 401 capable of supplying water to the steam supply 800 and a water discharge container 402 configured to collect water condensed at the heat supply 340

The water supply container 401 and the water discharge container 402 may have the same or similar appearance but may have different bottom surfaces, rear surfaces or inner surfaces. Consequently, the aesthetics of the water storage 400 may be further enhanced.

The water supply container 401 and the water discharge container 402 may be detachably mounted at the front side of the machine compartment 300. As a result, the clothing treatment apparatus 1 according to the present disclosure may be installed at various regions, regardless of the position of a water supply source or a discharged water drain.

A drawer 50, which is configured to be drawn forwards and be retracted backwards and to have a separate receiving space, may be further provided at a front side of the machine compartment 300. The drawer 50 may store a steam generator or an iron therein.

FIG. 2 illustrates the structure of the machine compartment of the clothing treatment apparatus according to the present disclosure.

FIG. 2(a) illustrates the machine compartment 300 when viewed from the front. FIG. 2(b) illustrates the machine compartment 300 when viewed from the rear.

Components, which are configured to supply hot air to the accommodation space, to circulate the air in the accommodation space, to supply steam to the accommodation space, and to purify air outside the cabinet, may be disposed in the machine compartment 300.

The machine compartment 300 may include a base 310 by which various components are supported or mounted. The base 310 may provide an area on which the various components are mounted.

A circulation duct 320, through which air introduced from the outside of the inner case 200 or the cabinet 100 flows, may be mounted on the base 310.

The circulation duct 320 may be constructed to have a case shape which is open at the upper surface thereof and to allow some of the components of heat supply 340 to be mounted therein.

When the heat supply 340 is embodied as a heat pump system, the circulation duct 320 may include therein a heat exchanger 341 and 342, which will be described later, and a compressor 342 configured to supply high temperature and pressure refrigerant to the heat exchanger.

The heat exchanger 341 and 342 may be received in the circulation duct 320 so as to cool and thus dehumidify the air flowing in the circulation duct 320 and to heat the air to create hot air.

When the circulation duct 320 is configured to draw in air outside the cabinet 100, an external air duct 370 may be installed at the front side of the circulation duct 320.

The circulation duct 320 may communicate with the outside air duct 370 to selectively draw in external air.

The water supply container and the water discharge container may be detachably coupled to the front surface of the circulation duct 320. The water supply container 401 and the water discharge container 402 may be disposed and mounted on the upper portion of the external air duct 370

Although the circulation duct 320 may be constructed so as to be coupled to the base 310, the circulation duct 320 may also be constructed integrally with the base 310. For example, the base 310 and the circulation duct 320 may be produced through injection molding.

The machine compartment 300 may include a base cover 360 configured to allow the circulation duct 320 and the introduction hole 231 to communicate with each other.

The base cover 360 may be coupled to the upper portion of the circulation duct 320 so as to guide the air drawn in through the introduction hole 231 to the inside of the circulation duct 320.

The base cover 360 may block the upper surface of the circulation duct 320 to prevent the air inside the circulation duct 320 from being discharged to the outside. The lower portion of the base cover 360 and the upper surface of the circulation duct 320 may define one surface of the flow channel in the circulation duct 320.

The base cover 360 may include an introduction portion 362 which connects the introduction hole 231 to the circulation duct 320. The introduction portion 362 may be constructed to have a duct shape so as to serve as an intake duct configured to transfer the air in the inner case 200 to the circulation duct 320.

The machine compartment 300 may include the steam supply 800, which is connected to the water supply container 401 so as to receive water from the water supply container 401 to create steam and to supply the steam the inner case 200. The steam supply 800 may be disposed and mounted on the upper portion of the base cover 360.

The steam supply 800 may be disposed behind the introduction portion 362.

The machine compartment 300 may include a fan installation portion 350 configured to allow the circulation duct 320 and the inner case 200 to communicate with each other. The fan installation portion 350 may include a blower fan 353 configured to provide power required to move the air in the circulation duct 320 in one direction, and a fan housing 350 which receives the blower fan 353 therein and is coupled to or extends to the circulation duct 320.

The fan installation portion 350 may include a discharge duct 352 configured to allow the circulation duct 320 and the discharge hole 232 to communicate with each other.

The discharge duct 352 may extend toward the discharge hole 232 while maintaining a cross-sectional area at the fan housing 350 corresponding to the cross-sectional area of the discharge hole 232.

As a result, the air in the inner case 200 may be introduced through the base cover 360, may pass through the circulation duct 320, and may be supplied to the inside of the inner case 200 through the fan installation portion 350.

The base 310 may include a compressor installation portion 313 on which the compressor 342 configured to supply refrigerant to the heat exchanger 341 and 343 is mounted. The compressor installation portion 313 may be disposed outside the circulation duct 320.

A controller or a control panel 700, which is configured to control the clothing treatment apparatus according to the present disclosure, may be mounted on the base 310.

The base 310 may include a controller installation portion 312, which is provided at the lower portion of the circulation duct 320 to provide a space in which the controller 700 is inserted.

The controller 700 may be configured to control all the components, which are electronically controlled, such as the compressor 342, the steam supply 800 and the blower fan 353.

Because the controller 700 is inserted into the base 310 and is supported thereby, it is possible to reduce vibration or impact applied to the controller 700. Furthermore, because the controller 700 is disposed close to all the electronic components, it is possible to minimize occurrence of errors in control such as noise.

The steam supply may be disposed at the upper portion of the circulation duct 320, and the controller 700 may be disposed at the lower portion of the circulation duct 320. Consequently, the circulation duct 320 may be linearly disposed between the steam supply 800 and the controller 700 so as to take the shape of a linear duct. As a result, it is possible to minimize the resistance to air flowing in the circulation duct 320.

The circulation duct 320, the external air duct 370, the steam supply 800, the controller 700, and the heat supply 340 may be provided at the base 310 in a modular fashion.

Consequently, the base 310 may be forwardly taken out of and backwardly put into the machine compartment 300, thereby facilitating installation and maintenance of the clothing treatment apparatus.

FIG. 3 illustrates the structure of the base of the machine compartment of the clothing treatment apparatus according to the present disclosure.

FIG. 3(a) is a perspective view of the base 310 when viewed from the front. FIGS. 3(b) and 3(c) are perspective views of the base 310 when viewed from the rear.

The base 310 may be mounted on the base plate defining the lower surface of the clothing treatment apparatus. The base 310 may also define the lower surface of the clothing treatment apparatus by itself.

The base 310 may include a base bottom 311 serving as a support surface. The base bottom 311 may define the lower surface of the clothing treatment apparatus. The base bottom 311 may be mounted on the upper surface of the bottom of the cabinet 100, which defines the lower surface of the clothing treatment apparatus.

The base 310 may be formed integrally with the circulation duct 320, which forms at least a portion of the flow channel through which air flows. The circulation duct 320 may extend upwards from the base bottom 311.

The circulation duct 320 may include a duct body 321, which extends from the base bottom 311 to define a flow channel, a heat exchanger installation portion 3212, which is defined in the duct body 321 so as to have a space in which the evaporator 341 or the condenser 343 is mounted, and an air discharge portion 323, which is provided at the rear side of the duct body 321 so as to allow the air in the duct body 321 to be discharged therethrough.

The air discharge portion 323 may extend backwards from the duct body 321 in the shape of a pipe. The air discharge portion 323 may have a diameter smaller than the width of the duct body 321.

The air discharge portion 323 may be connected to the fan housing 350. The air discharged from the air discharge portion 323 may be guided into the inner case 200 through the fan housing 350.

The circulation duct 320 may include an external air intake portion 322, which is formed through the front surface of the duct body 321.

The external air intake portion 322 may be constructed so as to communicate with the external air duct 370. The external air duct 370 may be mounted on the front side of the external air intake portion 322 and be supported thereby.

The circulation duct 320 may be provided with a damper configured to open and close the external air intake portion 322. Opening and closing of the damper may allow and block introduction of external air into the circulation duct 320.

The base 310 may include the compressor installation portion 313 which has a space in which the compressor 342 is mounted. The compressor installation portion 313 may be formed at a portion of the base bottom 311, and may be formed integrally with the base bottom 311.

The compressor installation portion 313 may include a protrusion capable of supporting the compressor 342. The compressor installation portion 313 may be disposed at the rear side of the base 310. The compressor installation portion 313 may be disposed such that at least a portion thereof overlaps the air discharge portion 323 in the width direction.

The compressor installation portion 313 may be provided with a shock absorber configured to reduce vibration transmitted from the compressor 342. The shock absorber may be fixed to the protrusion.

The base 310 may include the controller installation portion 312 on which the controller 700 is mounted. The controller installation portion 312 may be formed between the base bottom 311 and the circulation duct 320. The controller installation portion 312 may be formed between the base bottom 311 and the bottom surface of the circulation duct 320. The controller installation portion 312 may be disposed below the circulation duct 320, and may be constructed in the shape of a duct which is open at one of the front and rear sides thereof.

The structure of the controller installation portion 313 will be described later.

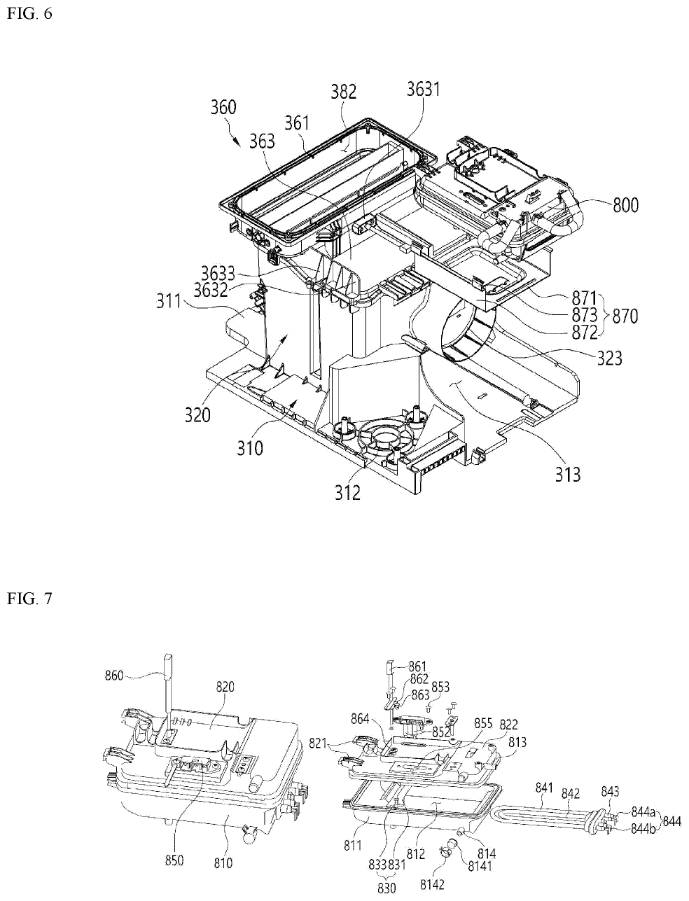

FIG. 6 illustrates the structure of the circulation duct of the clothing treatment apparatus according to the present disclosure.

The circulation duct 320 may define a flow channel which extends upwards from the base bottom and through which air flows. The circulation duct 320 may include the heat exchanger installation portion 3212 which has a space in which the evaporator 341 and the condenser 342 are mounted. The heat exchanger installation portion 3212 may be provided in the duct body 321.

The duct body 321 may be open at the upper surface thereof. The evaporator 341 and the condenser 343 may be introduced and mounted through the opening of the duct body 321.

The opening of the duct body 321 may be blocked by the base cover 360, and the base cover 360 and the duct body 321 may define the flow channel in the circulation passage 320.

The front surface of the duct body 321 may be disposed at a location which is spaced backwards apart from the front end of the base bottom 311.

Consequently, the base bottom 311 may ensure a support surface 3111 on which one or more of the water supply container 401, the water discharge container 402 and the external air duct 370 are mounted and supported.

The heat supply 340 may include the evaporator 341, which is provided in the circulation duct 320 and serves as the heat exchanger configured to cool and dehumidify the air introduced into the circulation duct 320, the condenser 343 serving as the heat exchanger configured to heat the air having passed through the condenser 341 to create hot air, the compressor 342, which is disposed outside the circulation duct 320 and which supplies refrigerant to the condenser 343 to exchange heat with the air, and an expansion valve 344 configured to expand and cool the refrigerant having passing through the condenser 343.

Because the duct body 32 is formed integrally with the base 310, the heat exchanger installation portion 3212 may ensure a greater height, and the heights of the condenser 343 and the evaporator 341 may increase.

As a result, because the widths of the condenser 343 and the evaporator 341 in the forward/backward direction are reduced, it is possible to reduce the number of refrigerant pipes which extend through the condenser and the evaporator. Consequently, there is an effect of reducing flow loss of air which passes through the condenser and the evaporator.

The sum of the length of the evaporator 341 and the length of the condenser 343 may be less than the length of the heat exchanger installation portion 3212. Consequently, the length of the heat exchanger installation portion 3212 may be equal to or less than the half of the length of the duct body 321.

Accordingly, because the heat exchanger installation portion 3212 is sufficiently spaced apart from the external air intake portion, it is possible to ensure a sufficient space into which the air in the inner case 200 is introduced.

The inside of the duct body 321 may be provided with an installation partition wall 3211 configured to isolate the heat exchanger installation portion 3212 from the outside of the heat exchanger installation portion 3212. The installation partition wall 3211 may project from the lateral surface of the duct body 321 to support the front portion of the evaporator 341.

The duct body 321 may extend backwards while increasing in width based on the installation partition wall 3211.

As a result, the width of the heat exchanger installation portion 3212 may be greater than the half of the width of the base 310. Furthermore, the width of the circulation duct 320 may be greater than the half of the width of the base 310.

In addition, the width of the condenser 343 and the width of the evaporator 341 may be greater than half the entire width of the base 310.

When the condenser 343 and the evaporator 341 have the widths as described above, there is an effect of ensuring a sufficient heat exchanging capacity.

The fan housing 350 may be disposed so as to overlap the condenser 343 or the evaporator 341 in the forward/backward direction. Consequently, the air having passing through the evaporator 341 and the condenser 343 may be introduced into the fan housing 350 without passing through a bent flow channel portion. In other words, because the air, which is introduced into the circulation duct 320, moves to the fan housing without passing through a bent flow channel portion, there is an effect of minimizing flow loss of the air.

FIG. 5 illustrates the structure of the base cover of the clothing treatment apparatus according to the present disclosure.

The base cover 360 may be coupled to the upper surface of the circulation duct 320 to prevent the inside of the circulation duct 320 from being exposed.

The base cover 360 may include an introduction body 361, which is coupled to the upper surface of the circulation duct 320 so as to allow the inner case 200 to communicate with the circulation duct 320, and a shield body 363, which extends from the introduction body 361 to shield the circulation duct 320.

The introduction body 361 may be formed so as to have the shape of a duct which allows the introduction hole 231 in the inner case to communicate with the inside of the circulation duct 320. The introduction body 361 may project upwards farther than the shield body 363.

The introduction body 361 may be disposed in front of the evaporator 341 so as not to face the evaporator 341 and the condenser 343, and may be disposed in front of the installation partition wall 3211.

The introduction body 361 may serve as an introduction duct through which the air in the inner case 200 moves to the circulation duct 320.

The introduction body 361 may include therein the introduction portion 362 through which the air in the inner case 200 passes.

Specifically, the base cover 360 may include a first rib 362a, which extends in the width direction of the introduction body 361, and a second rib 362b, which is spaced backwards apart from the first rib 362a and extends in the width direction of the introduction body 361.

The first rib 362a and the second rib 362b may be disposed parallel to each other. Each of the first rib 362a and the second rib 362b may be formed so as to have the shape of a plate which extends in a vertical direction and has a height corresponding to the height of the introduction body 361.

The front edge of the introduction body 361 and the first rib 362a may define a first introduction port 3611 therebetween. The first rib 362a and the second rib 362b may define a second introduction port 3622 therebetween. The second rib 362b and the rear edge of the introduction body 361 may define a third introduction port 3623 therebetween.

The first introduction port 3611 and the third introduction port 3622 may have the same area, and the second introduction port 36222 may have a smaller area than the area of each of the first introduction port 3611 and the third introduction port 3622.

The base cover 360 may include a damper portion 364 configured to open and close the introduction portion 362, and a driving portion 355 which is coupled to the damper portion 364 and controls opening and closing of the damper portion 364.

The damper portion 364 may include a first damper portion 364 configured to open and close the first introduction port 3611, and a second damper portion 365 configured to open and close the third introduction port 3623.

The first damper portion 364 may be formed so as to have the shape of a plate which has a surface area corresponding to the first introduction port 3611, and may be rotatably coupled to two opposite lateral surfaces of the introduction body 361 in the first introduction port 3611.

The second damper portion 365 may be formed so as to have the shape of a plate which has a surface area corresponding to the third introduction 3622, and may be rotatably coupled to two opposite lateral surfaces of the introduction body 361 in the third introduction port 3622.

The second introduction port 3622 may include a shield filter 366 configured to filter out foreign matter such as fine dust and lint but allowing air to pass therethrough.

The shield filter 366 may be inserted into the second introduction port 3622 so as to isolate the first introduction port 3611 and the third introduction port 3623. The shield filter 366 may extend from the second introduction port 3622 so as to contact the bottom surface of the circulation duct 320.

The shield filter 366 may be embodied as a filter capable of also filtering moisture. For example, the shield filter 366 may be embodied as a HEPA filter or the like.

In the case in which the shield filter 366 is inserted into the second introduction port 3622, a shield member configured to shield the second introduction port 3622 may further be coupled to the second introduction port 3622.

The driving portion 355 may include a motor configured to provide power required to selectively rotate the first damper portion 364 and the second damper portion 365, and a plurality of gears capable of selectively rotating the first damper portion 364 and the second damper portion 365.

By virtue of the driving portion 355, it is possible to selectively open the first introduction port 3611 and the third introduction port 3623.

By virtue of the driving portion 355, the air contained in the inner case 200 may be introduced into the circulation duct 320 through the first introduction port 3611 or through the third introduction port 3623.

Of course, the driving portion 355 may control the first damper portion 364 and the second damper portion 365 so as to open both the first introduction port 3611 and the third introduction port 3623 and to shield both the first introduction port 3611 and the third introduction port 3622.

As long as the driving port 365 is configured to be capable of rotating the first damper portion 364 and the second damper portion 365, the driving portion 355 may be embodied as any structure. For example, the driving port 365 may be embodied as a combination of a motor, a driving gear configured to be rotated by the motor, and a follower gear which is coupled both to the first damper portion and to the second damper portion and is rotated by the driving gear.

The base cover 360 may include the shield body 363 which extends from the introduction body 361 to shield the evaporator 341 and the condenser 343. The shield body 363 may be formed so as to have the shape of a plate.

The base cover 360 may be detachably coupled to the upper surface of the circulation duct 320 via an introduction hook 3612 which extends from the lower surface of the introduction body 361.

The circulation duct 320 may include a coupler which is detachably coupled to the introduction hook 3612.

FIG. 6 illustrates an installation structure of the steam supply.

The steam supply 800 may be seated on the base cover 360 and be supported thereby.

The steam supply 800 may be seated on the base cover 360, and may include a steam generator 810 configured to store water for generation of steam.

The steam supply 800 may further include an installation bracket 870 configured to enable the steam generator 810 to be fixed to the base cover 360.

The installation bracket 870 may be coupled to the base cover 360 to fix the steam generator 810.

The installation bracket 870 may include a lower panel 871 configured to support the lower surface of the steam generator 810 and lateral panels 872 which extend from the lower panel 871 to support the lateral surfaces of the steam generator 810.

The installation bracket 870 may further include one or more holding clips 873 which extend from the lateral panels 872 to prevent separation of the steam generator 810.

The holding clips 873 may be detachably provided on the upper portion or the lateral surfaces of the steam generator 810.

The compressor 342 may be disposed lower than the steam supply 800.

The installation bracket 870 may be configured to prevent the heat generated from the compressor or the heat generated from the refrigerant compressed by the compressor from being transmitted to the steam supply 800.

The installation bracket 870 may also be configured to prevent fire occurring at the compressor 342 from spreading to the steam supply 800.

The base cover 360 may include a fastener 3631 which is provided at the shield body 363 so as to be detachably coupled to the steam supply 800. The fastener 3631 may be constructed so as to be detachably coupled to a projection projecting from the lower portion of the steam generator 810.

As a result, even when a large amount of water is received in the steam generator 810, the steam generator 810 may be stably seated on the base cover 360.

In addition, because the steam generator 810 is disposed higher than the circulation duct 320 such that the distance to the inner case 200 is reduced, it is possible to minimize condensation of the steam generated from the steam generator 810 prior to reaching the inner case 200.

FIG. 7 illustrates the detailed structure of the steam supply.

Referring to FIG. 7(a), the steam supply 800 may include the steam generator 810 configured to receive and store therein water for generation of steam, and a heater unit 840 which is received in the steam generator 810 and heats the water to generate steam.

The steam generator 810 may be constructed to have the form of a case defining the space configured to receive the heater unit 840.

For example, the steam generator 810 may be constructed to have the form of a case having an open surface and to receive the heater unit 840 therein.

The steam supply 800 may further include a case cover 820 which is coupled to the steam generator 810 so as to prevent exposure of the heater unit 840 to the outside and to prevent outflow of the water.

The case cover 820 may be provided with a water level sensor 850 configured to sense the level of the water in the steam generator 810, and a steam sensor 860 configured to sense the internal temperature of the steam generator 810 or to sense whether or not steam is generated in the steam generator 810.

Referring to FIG. 7(b), the steam generator 810 may include a case body 811 configured to provide a space configured to store the water therein and receive the heater unit 840 therein.

The case body 811 may be open at the upper surface thereof such that various components can be easily installed in the case body 811.

The case body 811 may include a heater insertion hole 8111 which is formed through one side of the case body 811 such that the heater unit 840 is inserted into and drawn out of the case body 811.

The case body 811 may include therein a recovery pipe 814 to which water for generation of steam is supplied.

The recovery pipe 814 may also be configured to allow the water stored in the case body 811 to be discharged to the outside.

The recovery pipe 814 may be maintained in a closed state by means of a blocking cap 8141 but be opened only when the residual water in the steam generator 810 is removed, and may include a blocking clip 8142 configured to maintain the blocking cap 8141 in the state of being coupled to the recovery pipe 814 to prevent the blocking cap 8141 from being unintentionally separated.

Consequently, the water contained in the steam generator 800 may be discharged through the recovery pipe 814 when it is required to repair the steam generator 800 or prevent the steam generator 800 from being frozen to burst.

Of course, the recovery pipe 814 may be configured to receive water from the water supply container 401. The detailed description thereof will be given later.

The case body 811 may be provided therein with a heater holder 830 configured to support or hold the heater unit 840. The heater holder 830 may include a holding clip 831 configured to hold the heater unit 840, and a clip fastening member 833 configured to fasten the holding clip 831 to the case body 811.

The holding clip 831 may be constructed so as to receive or surround at least a portion of the heater unit 840.

The steam supply 800 may include a water supply pipe 815 through which water is supplied to the steam supply 800. The water supply pipe 815 may communicate with the water supply container 401 to allow water to be supplied to the steam supply 800.

The water supply pipe 815 may be provided at the case cover 820 or be disposed at the upper portion of the steam generator 810. Accordingly, it is possible to prevent backflow of water through the water supply pipe 815.

The steam supply 800 may include a steam pipe 813 configured to discharge the steam, generated by activation of the heater unit 840, to the outside. The steam pipe 813 may also be provided at the upper portion of the case cover 820 so as to prevent water from being unintentionally discharged through the steam pipe 813.

The steam pipe 813 may communicate with the steam hole 233 of the inner case 200.

The case cover 820 may include a water level sensor hole 854 in which the water level sensor is mounted.

The water level sensor 850 may include one or more contact protrusions 852 which are inserted into the water level sensor hole 854 and immersed in water so as to sense a water level, and a sensor body 851 coupled to the water level sensor hole 854 or supported by the case cover 820 so as to maintain the contact protrusions 852 in the state of being suspended in the steam generator 810.

The sensor body 851 may be coupled to the case cover 820 by means of a sensor fastening member 853.

The case cover 820 may include an insertion hole 864 in which the steam sensor 860 is installed. The steam sensor 860 may include a sensing device 861 which is inserted into the insertion hole 864 so as to sense whether or not steam is generated in the steam generator 810, a support 863 configured to fix the sensing device 861 to the case cover 820, and a coupler 862 configured to couple the support 863 to the case cover 820.

The sensing device 861 may be embodied as a humidity sensor or a temperature sensor to sense whether or not steam is created in the steam generator 810.

The case cover 820 may include cover hooks 821 which extend forwards to be coupled to the base cover 860.

A fixing protrusion 822 may be provided behind the case cover 820 so as to fix the lower portion of the inner case 200 or an additional steam discharger 900.

The heater unit 840 may be received in the steam generator 810 through the heater insertion hole 8111 and may receive power to heat water.

The heater unit 840 may be embodied as a sheathed heater or the like, and may be controlled so as to be repeatedly activated and halted by the controller 700.

The heater unit 840 may include a first heater 841 configured to heat water using a first electric power supplied thereto, and a second heater 842 configured to heat water using electric power higher than the first electric power.

As a result, the second heater 842 may be configured so as to heat a larger amount of water and thus to create a larger amount of steam than the first heater 841.

The first heater 841 and the second heater 842 may share and consume the maximum electrical energy supplied to the heater unit 840 of the clothing treatment apparatus. In other words, when the first heater 841 is configured to consume a portion of the maximum electrical energy, the second heater 842 may be configured to consume the remaining portion of the maximum electrical energy.

For example, when the typical maximum electrical energy applied to the heater unit 840 is 1500 W, the first heater 841 may be configured to consume 600 W while the second heater 842 may be configured to consume 880 W. The remaining 20 W may be provided as spare electrical energy in consideration of error and the like.

The heater unit 840 may include, for example, three or more heaters. For example, the heater unit 840 may include the first heater 841, the second heater 842 and a third heater 843, and the first heater 841, the second heater 842 and the third heater 843 may share the maximum electrical energy and consume the divided amounts of electrical energy.

Hereinafter, the heater unit 340 will be described based on the case in which the heater unit 340 includes the first heater 841 and the second heater 842.

Each of the first heater 841 and the second heater 842 may be made of a U-shaped metal pipe.

The heater unit 840 may include a heater seal 843 which fixes the first heater 841 and the second heater 842 and seals the heater insertion hole 8111, and a terminal unit 844 through which current is supplied to the first heater 841 and the second heater 842.

The terminal unit 844 may include a first terminal 844a through which current is supplied to the first heater 841, and a second terminal 844b through which current is supplied to the second heater 842.

The first heater 841 and the second heater 842 may be disposed at the same level. Consequently, the first heater 841 and the second heater 842 may be configured to heat water at the same level to create steam.

To this end, the controller 700 may control an amount of generated steam and an amount of consumed electrical energy selectively using one or both of the first heater 841 and the second heater 842.

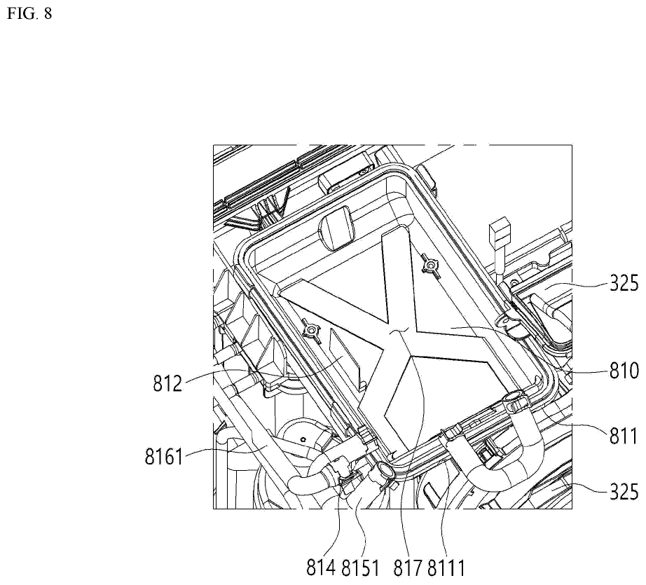

FIG. 8 illustrates the interior of the steam generator.

The steam generator 810 may include a heating space 817 configured to store water therein and to receive the heater unit 840 therein.

The steam generator 810 may receive water for generation of steam through a water supply hose 8151 connected to the water supply pipe 815.

The steam, which is generated by activation of the heater unit 840 of the steam generator 810, may be discharged to the outside of the steam supply 800 along the steam hose 8131 through the steam discharge pipe 813.

The steam hose 8131 may communicate with the steam hole 233 in the inner case 200.

The steam generator 810 may include a partition wall 812 configured to separate the heating space 817 and the water level sensor 850 from each other. In other words, the partition wall 812 may be constructed so as to separate the heater unit 840 and the water level sensor 850 from each other, and may be biasedly disposed at one side of the base body 811.

The water level sensor 850 may be disposed between the partition wall 812 and the inner surface of the case body 811.

Consequently, it is possible to prevent the vibration of water generated during boiling of the water from being transmitted to the water level sensor 850, and to prevent the heat generated from the heater unit 840 from being directly transmitted to the water level sensor 850.

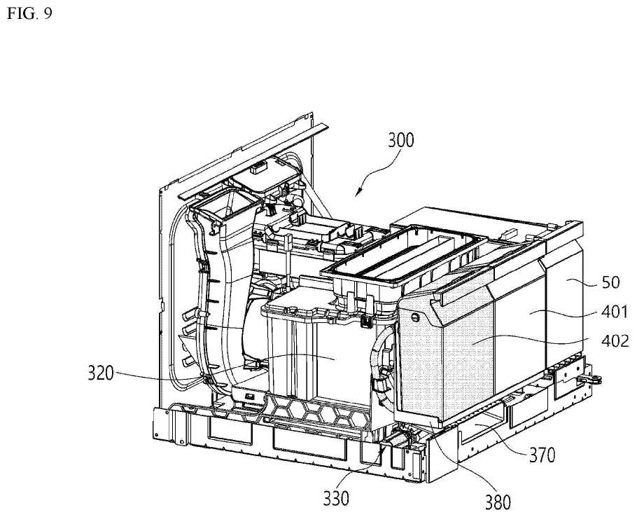

FIG. 9 illustrates the structure of the water storage of the clothing treatment apparatus according to the present disclosure.

The water storage 400 may be disposed in front of the machine compartment 300 or the duct body 321. Accordingly, the water storage 400 may be easily separated from and seated on the machine compartment 300 by a user.

Specifically, only when the water discharge container 402 is disposed in front of the duct body 321 is it easy for a user to separate the water collected in the water discharge container 402 from the machine compartment 300 and then to discard the water to the outside.

Furthermore, the water supply container 401 should also be disposed in front of the duct body 321 so that the user can easily separate the water supply container 401 from the machine compartment 300 and then fill the water supply container 401 with water.

The clothing treatment apparatus according to the present disclosure may further include an attachment 380, which is disposed in front of the circulation duct 320 and by which the water supply container 401 and the water discharge container 402 are detachably supported.

The attachment 380 may be disposed higher than the external air duct 370, and may support the load of at least one of the water supply container 401, the water discharge container 402 and the drawer 50.

The attachment 380 may be fixed in the front of the circulation duct 320.

The clothing treatment apparatus according to the present disclosure may include a residual water treatment unit 330 configured to guide the water condensed in the circulation duct 320 toward the water discharge container 402.

The residual water treatment unit 330 is mainly disposed in front of the duct body 321 in order to reduce the distance between the residual water treatment unit 330 and the water discharge container 402.

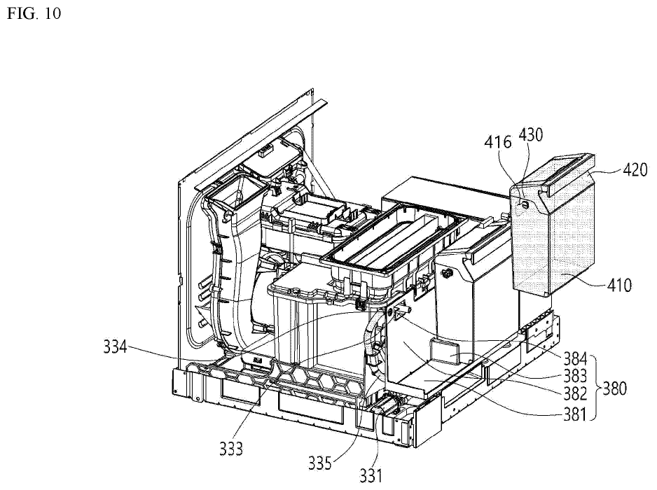

FIG. 10 illustrates the arrangement in which the water storage of the clothing treatment apparatus according to the present disclosure is mounted on and removed from the attachment.

The water storage 400 may include a storage body 410 configured store condensed water therein, and a handle part 430 which is detachably coupled to the upper portion of the storage body so as to support the load of the storage body 410.

The storage body 410 of the water supply container 401 and the storage body 410 of the water discharge container 402 may have a similar form, and the handle part 430 of the water supply container 401 and the handle part 430 of the water discharge container 402 may have the same form.

The storage body 410 of the water supply container 401 and the storage body 410 of the water discharge container 402 may be different from each other in positions of an inflow hole and an outflow hole but may be identical to each other in the remaining structure.

The storage body 410 may be constructed to have the form of a box configured to store water therein. The storage body 410 may include a stopper 450, which projects from one side thereof and is detachably fastened to the attachment 380. The structure of the stopper 450 will be described later.

The water storage 400 may be mounted on and separated from the attachment 380 by external force applied thereto from a user.

The water supply container 401 and the water discharge container 402 may be separated from the attachment 380 when forward and upward external force is applied thereto by the handle 450.

The water supply container 401 and the water discharge container 402 may be pulled out of a reception groove 382 in a forward direction or in a forward and upward direction.

Meanwhile, the water supply container 401 and the water discharge container 402 may be seated on and coupled to the attachment 380.

The water supply container 401 and the water discharge container 402 may be coupled to the reception groove 382 such that the water supply container 401 and the water discharge container 402 cannot be unintentionally separated from the attachment 380 once the water supply container 401 and the water discharge container 402 are seated in the reception groove 382.

For example, the water supply container 401 and the water discharge container 402 may be detachably coupled in the reception groove 382 by means of the stoppers 450 which project from both lateral surfaces of each of the water supply container 401 and the water discharge container 402. Consequently, it is possible to prevent the water storage 400 from being unintentionally separated even when vibration is generated in the clothing treatment apparatus.

The storage body 410 may include a hole through which water is supplied or discharged. For example, the storage body 410 of the water discharge container 401 may include a supply hole 416 formed in the rear surface thereof. The supply hole 416 may be formed through the rear surface of the storage body 410, and may be disposed closer to the upper surface of the storage body 410 than to the bottom surface of the storage body 410. Accordingly, when the storage body 410 is embodied as the storage body of the water discharge container 401, it is possible to stably store water up to the level corresponding to the supply hole 44.

The attachment 380 may include the reception groove 382, which is bent or depressed toward the machine compartment 300 so as to be disposed in front of the circulation duct 320 and to provide a space in which the water supply container 401 and the water discharge container 402 are seated and a reception body 381 capable of supporting the water supply container 401, the water discharge container 402 and the drawer 50.

The reception body 381 may be constructed to have a plate shape or a case shape, and may be fixed to the front side of the circulation duct 320. The reception groove 382 may be configured to allow the water supply container 401 and the water discharge container 402 to be received in the reception body 381.

The attachment 380 may further include a central separator 383 which is disposed between the water supply container 401 and the water discharge container 402 so as to separate the water supply container 401 from the water discharge container 402.

The central separator 383 may support the water supply container 401 and the water discharge container 402 in the state of spacing them apart from each other. Consequently, it is possible to prevent one of the water supply container 401 and the water discharge container 402 from being unintentionally taken out while the other of the water supply container 401 and the water discharge container 402 is taken out.

The residual water treatment unit 330 may include a water discharge pump 331, which receives water from a water discharge pipe communicating with the bottom of the circulation duct 320, and a water discharge hose 335 through which water from the water discharge pump 331 is discharged. The water discharge hose 335 may guide the water from the water discharge pump 331 toward the water discharge container 402.

The attachment 380 may include a water discharge hole 3823 which is formed through the reception groove 382 such that the water discharge hose 335 communicates with the water discharge container 402.

The residual water treatment unit 334 according to the present disclosure may further include a discharge pipe 334 which allows the water discharge hose 335 to communicate with the water discharge container 402. The discharge pipe 334 may be configured to receive water from the water discharge hose 335 and to guide the water to the supply hole 416.

The discharge pipe 334 may extend from the circulation duct 320 or the attachment 380. The discharge pipe 334 may be formed through injection molding. Consequently, it is possible to stably fix the distal end of the water discharge hose 335 and to prevent the water discharge hose 335 from being steeply bent.

Furthermore, the discharge pipe 334 may be injection-molded in the form of a pipe which is fixed to the circulation duct 320 or the attachment 380, and may be securely fixed always in the installed state. Accordingly, the distal end of the discharge pipe 334 and the supply hole 416 are always correctly positioned, and thus the condensed water supplied from the water discharge pump 331 may be stably introduced into the water discharge container 402.

The clothing treatment apparatus according to the present disclosure may further include a backflow portion 333 configured to allow the water received in the water discharge container 402 to flow back to the circulation duct 320 or the residual water treatment unit 330.

The backflow portion 330 may be disposed at a position corresponding to the supply hole 44 such that the water in the water discharge container 402 is guided thereto.

The water supply container 401 may be constructed so as to have an almost identical structure to the water discharge container 402. The water supply container 401 may include a discharge hole 417 formed in the lower portion thereof through which the water contained in the storage body 410 is discharged. As a result, the water contained in the storage body 410 may be wholly discharged from the storage body 410 due to the influence of gravity.

The attachment 380 may further include a water supply hole 3824 which is formed in the reception groove 382 so as to communicate with the discharge hole 417.

The clothing treatment apparatus according to the present disclosure may further include a water supply pump configured to supply the water supplied from the water supply hole 3824 to the steam generator 810, and the water supply pipe.

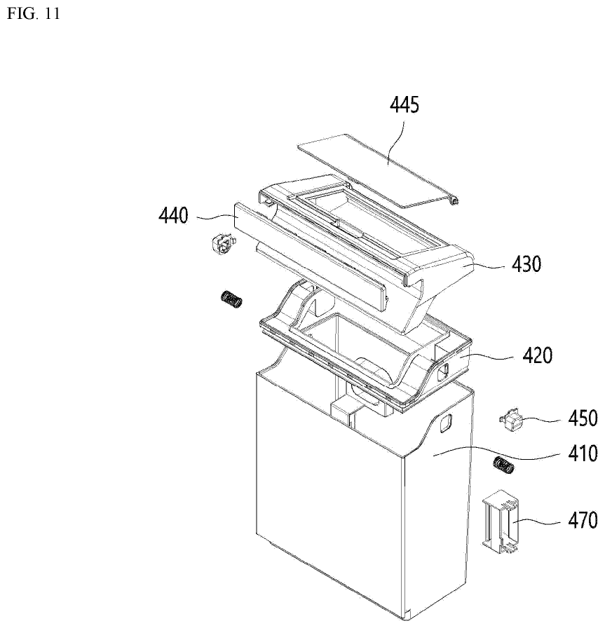

FIG. 11 illustrates an example of the structure of the water storage.

The water discharge container 402 and the water supply container 401 may be constructed to have almost the same structure, except positions at which water is discharged and introduced and the position at which the sensor is installed.

Accordingly, although the structure of the water storage 400 will be described based on the water discharge container 402, the description may also be applied to the water supply container 401.

The water storage 400 may include the storage body 410 configured to store water therein.

The storage body 410 may be constructed to have the form of a box configured to store water therein. For example, the storage body 410 may be constructed to have a hexahedral form.

The storage body 410 may have a height longer than the width or thickness thereof. The width may correspond to the dimension in a lateral direction, and the thickness may correspond to the dimension in the forward/backward direction.

Consequently, even when the reception groove 382 has a small width and the storage body 410 includes a plurality of storage bodies, the storage body 410 may receive a sufficient amount of water therein. As a result, the storage body 410 is capable of supplying a sufficient amount of water to the steam generator 810 or of receiving a sufficient amount of water condensed in the evaporator 341.

The storage body 410 may include an opening portion 412. The opening portion 412 may allow the water contained in the storage body 410 to be discharged to the outside or guide the water to the inside of the storage body 410.

The opening portion 412 may be provided at the upper portion of the storage body 410 such that the storage body 410 receives as much water as possible.

The opening portion 412 may be formed by opening the entire upper surface of the storage body 410. The upper surface of the storage body 410 may be entirely open to define the opening portion 412, and the cross-sectional area of the storage body 410 may be equal to the cross-sectional area of the opening portion 412.

Accordingly, the water contained in the storage body 410 may be discharged from the storage body 410 without remaining therein, and a large amount of water may be quickly introduced into the storage body 410.

Furthermore, because the interior of the storage body 410 is entirely exposed through the opening portion 412, a user body, various tools and substances and the like may be easily introduced into and discharged from the storage body 410. As a result, it is possible to optimize the efficiency of disinfection, sterilization and cleaning of the storage body 410.

Because the opening portion 412 in the storage body 410 has a large area, there is a need to hermetically seal the opening portion 412. Accordingly, the water storage 400 according to the present disclosure may further include a cover part 420 which is coupled to the storage body 410 so as to close the opening portion 412.

The cover part 420 may be partially inserted into the opening portion 412 so as to close the storage body 410. The cover part 420 may be configured to seal the inner surface of the storage body 410. Consequently, the cover part 420 is capable of preventing the water contained in the storage body 410 from leaking to the outside of the opening portion 412.

When the cover part 420 is coupled to the storage body 410 so as to close the opening portion 412, the cover part 420 may be partially exposed to the outside of the storage body 410. Accordingly, it is possible for a user to easily grip the cover part 420 and then to easily separate the cover part 420 from the storage body 410.

The water storage 400 may further include the handle part 430 which is coupled to the cover part 420 so as to be separated from the storage body 410 together with the cover part 420. The handle part 430 may be coupled to the upper portion of the cover part 420. The handle part 430 may has an effect of further enlarging the area of the storage body 410 that is exposed to the outside. The handle part 430 may be constructed to have a structure such that the storage body 410 can be lifted by user fingers.

Consequently, the cover part 420 may be easily separated from the storage body 410 by virtue of the handle 420.

Furthermore, because the storage body 410 is supported by the handle part 430, the entire water storage 400 may be easily separated from the attachment 380 and be easily moved in the state of being coupled to the handle part 430.

The water storage 400 may include the stopper 450 which enables the cover part 420 and the handle part 430 to be selectively coupled to the storage body 410. The stopper 450 is capable of coupling the cover part 420 and the handle part 430 to the storage body 410.

The coupling force with which the stopper 450 couples the cover part 420 and the handle part 430 to the storage body 410 may be higher than the gravity applied to the storage body 410 when the storage body 410 is fully filled with water. Accordingly, the entire storage body 410 may be moved by virtue of the handle part 430.

The stopper 450 is capable of selectively fixing the cover part 420 and the handle part 430 to the storage body 410. Consequently, a user is able to separate the cover part 420 and the handle part 430 from the storage body 510 to open the opening portion 423 whenever necessary.

The water storage 40 may further include a grip portion 440 coupled to the handle part 430 in order to increase the contact area between the handle part 430 and a user body. The grip portion 440 is capable of preventing a user body from slipping on the handle part 430 while allowing the storage body 410 to be rotated relative to the grip portion 440 by a certain angle. Accordingly, the storage body 410 may be stably moved.

Each of the cover part 420 and the handle part 430 may have a through hole which communicates with the opening portion 412. Accordingly, even when the cover part 420 is coupled to the storage body 410, water may be supplied to the storage body 410 through the through holes and the water in the storage body 410 may be discharged through the through holes.

The water storage 400 may include a cover door 445 configured to close the through hole formed in the handle part 430.

The cover door 445 may be configured to selectively open the through hole formed in the handle part 430, thereby preventing the water from being unintentionally discharged through the handle part 430.

The cover door 445 may be rotatably coupled to the handle part 430 so as to selectively close the through hole in the handle part 430. The area of the through hole in the handle part 430 and the area of the cover door 445 may be smaller than the area of the opening portion 412.

The water storage 400 may further include a sensor 470 which is installed in the storage body 410 so as to sense the level of the water contained in the storage body 410.

Although the sensor 470 of the water supply container 401 and the sensor 470 of the water discharge container 402 may be different from each other in position, functions thereof may be the same.

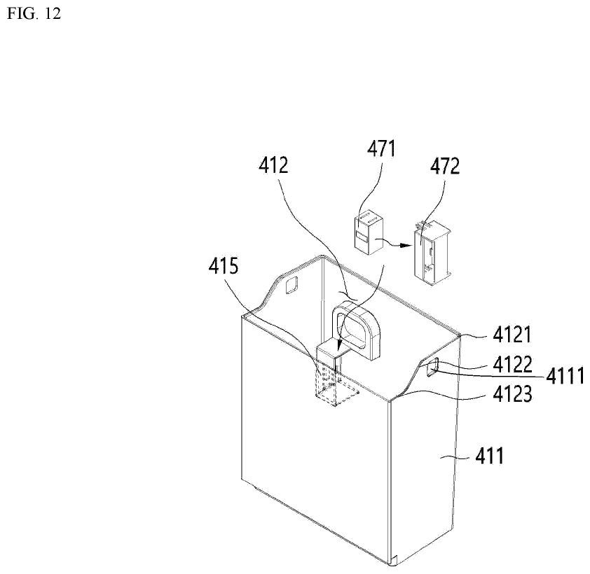

FIG. 12 illustrates an example of the detailed structure of the storage body.

The storage body 410 may include a water storage body 411 defining a accommodation space to store water therein, and the opening portion 412 formed in the upper portion of the water storage body 411.

The water storage body 411 may be detachably coupled to the stopper 450.

The water storage body 411 may include a groove formed in the inner surface thereof in which the stopper 450 is seated.

The water storage body 411 may include a coupling hole 4111 into which the stopper 450 is inserted and then coupled thereto.

When the water storage body 411 includes the coupling hole 4111, the stopper 450 may be coupled to the attachment 380 through the water storage body 411.

As a result, the stopper 450 is capable not only of detachably fixing the cover part 420 and the handle part 430 to the storage body 410 but also of detachably fixing the water storage 400 to the attachment 380.

The opening portion 412 may be formed by opening the entire upper surface of the water storage body 411. For example, the cross-sectional area of the opening portion 412 may be equal to the cross-sectional area of the water storage body 411.

The two lateral surfaces of the opening portion 412 and the upper surface of the water storage body 411 may be formed to be stepped.

Each of the two lateral surfaces of the opening portion 412 may include a first surface 4121 defining a portion of the upper surface of the water storage body 411, a second surface 4122 which extends downwards from the first surface 4121, and a third surface 4123 which extends from the second surface in a direction corresponding to the first surface.

The second surface e and the third surface may define a step or a stepped surface with respect to the first surface.

The first surface 4121 may have a length equal to or longer than the half of each of the two lateral surfaces of the opening portion 412, and the second surface 4122 may be disposed closer to the front side of the opening portion 412 than to the rear side of the opening portion 412.

The stopper 450 may be disposed under the first surface and behind the second surface. The length or the height of the second surface 4122 may be equal to or greater than the thickness of the portion of the stopper 450 that is exposed to the outside. Accordingly, the stopper 450 may be disposed so as to fully overlap the second surface 4122.

Consequently, even when the front side of the handle part 430 is supported by a user body, the rear side of the handle part 430 pushes the storage body 410 downwards, thereby cancelling out the force with which the front side of the storage body 410 is rotated downwards apart from the front side of the handle part 430. As a result, the coupled state between the storage body 410 and the handle part 430 or the cover part 420 may be maintained.

The storage body 410 may further include a sensor case 415 which enables the sensor 470 to be seated in the water storage body 411. The sensor case 415 may be constructed to have the form of a box which receives the sensor 470, and may include an open surface through which the sensor 470 is introduced thereinto and taken out thereof.

The sensor 470 may include a water level sensor 471 which is received in the sensor case 415 and fixed thereto. The water level sensor 471 may transmit the water level in the water storage 400 in real time through communication with the controller. Accordingly, the controller is capable of determining whether the water storage 400 is at full water level or low water level.

The sensor 470 may further include an installation body 472 which protects the water level sensor 471 and prevents electrical leakage of the water level sensor 471. The installation body 472 may be constructed to have a shape corresponding to the internal shape of the sensor case 415. Consequently, the water level sensor 471 may be stably fixed to the sensor case 415, thereby accurately sensing water level.

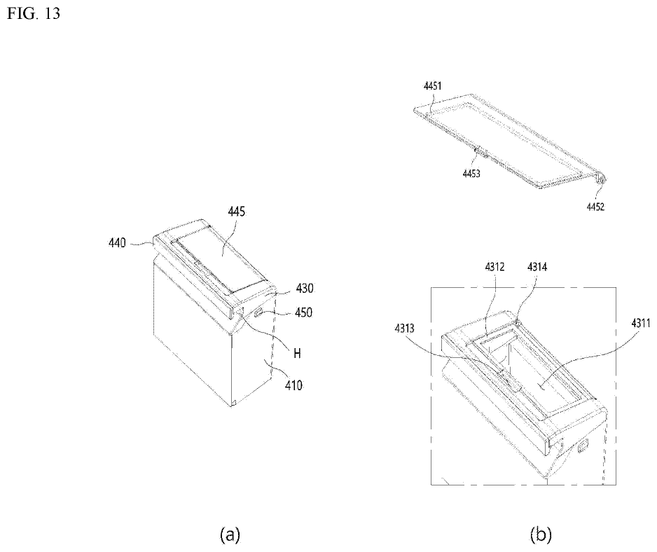

FIG. 13 illustrates the structure in which the handle communicates with the inside of the storage body.

Referring to FIG. 13(a), the handle part 430 may be securely fixed to the upper portion of the storage body 410.

The handle part 430 may be constructed to have a handle space H formed in the front side thereof into which a user hand is introduced. In other words, the front side of the handle part 430 may be depressed inwards so as to form the handle space H.

The grip portion 440 may shield a portion of the front side of the handle space H.

The cover door 445 configured to close the through hole in the handle part 430 may be rotatably coupled to the upper portion of the handle part 430.

Referring to FIG. 13(b), the cover door 445 may include a door body 4451 configured to close the through hole 4311 in the handle part 430, and a door hinge 4452 configured to rotatably couple the door body 4451 to the handle part 430. The door hinge 4452 may include a pair of door hinges which are respectively provided at rear portions of the two lateral sides of the door body 4451.

The cover door 445 may further include a coupling hook 4453 configured to secure the door body 4451 to the handle part 430 such that the door body 4451 does not unintentionally open the through hole 43311. The coupling hook 4453 may be disposed at the center of the front side of the door body 4451.

The handle part 430 may have the through hole formed in the upper portion thereof, which communicates with the inside of the storage body 410 or the opening portion 412. The through hole may also be referred to as a communication hole in order to be distinguished from the through hole in the cover part 420.

The area of the through hole 4311 may be set to be smaller than the area of the cover door 445. Consequently, the cover door 445 is capable of preventing water from leaking to the outside of the through hole 4311.

Furthermore, the area of the through hole 4311 may be set to be smaller than the cross-sectional area of the opening portion 412. Consequently, it is possible to prevent a large amount of water from being discharged to the outside of the through hole 4311 or being introduced into the through hole 4311 at one time.

The handle part 430 may include a seating groove 4312 which is formed by depressing at least a portion of the upper surface thereof so as to allow the cover door 445 to be seated therein. The seating groove 4312 may be formed along the periphery of the through hole 4311.

The seating groove 4312 may be provided in the front side thereof with a coupling groove 4313 to which the coupling hook 4453 is coupled. Of course, the positions of the coupling hook and the coupling groove may be reversed.

The seating groove 4312 may be provided at the two ends of the rear side thereof with a hinge portion 4314 to which the door hinge 4452 is rotatably coupled.

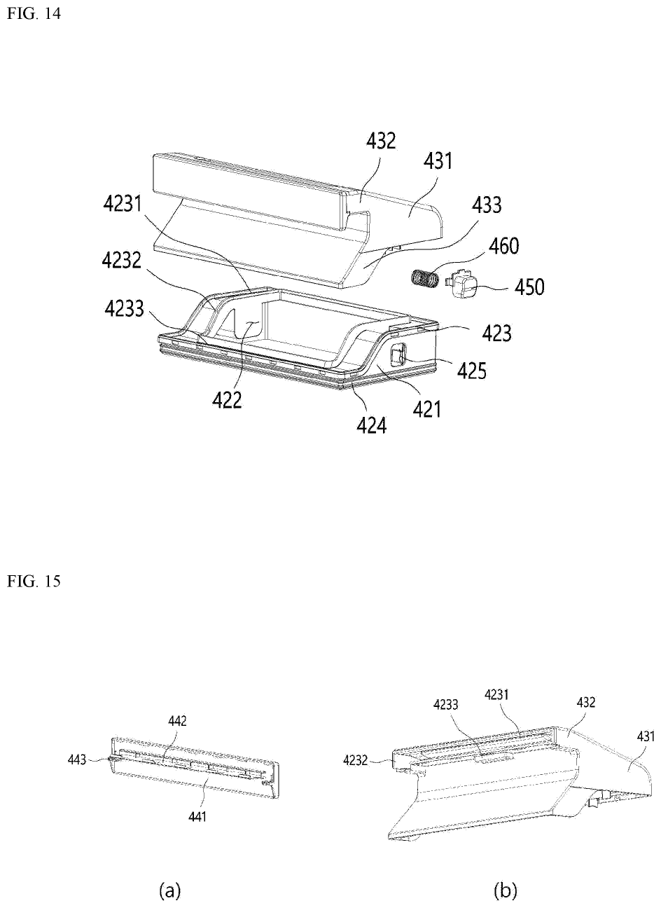

FIG. 14 illustrates an example of the structure configured to open and close the opening portion.

The cover part 420 may include a cover body 421, at least a portion of which is inserted into the opening portion 412, and a support surface 423 which is provided at the upper portion of the cover body 421 and is seated on the upper surface of the opening portion 412 or the upper surface of the water storage body 411.

At least a portion of the cover body 421 may be inserted into the opening portion 412 so as to face the inner surface of the storage body 410. Accordingly, the cover body 421 may be more stably coupled to the storage body 410.

The two lateral surfaces of the support surface 423 may be constructed to have a shape corresponding to the two lateral surfaces of the opening portion 412 or the upper surface of the water storage body 411.

The support surface 423 may be constructed to have a shape which is in surface contact with all of the first surface, the second surface and the third surface. Consequently, the support surface 423 may directly seal the opening portion 412, and may be in close contact with the storage body 410 in a more secure manner.

The support surface 423 may include an upper surface 4231 seated on the first surface, a sloped surface 4232 which extends downwards from the upper surface 4231 and is seated on the second surface, and a stepped surface 4233 which extends from the sloped surface and is seated on the third surface.

The cover part 420 may further include the through hole 422 which is formed through the cover body 412 so as to communicate with the opening portion 412. The through hole 422 may also be referred to as an introduction hole 422 in order to be distinguished from the communication hole 4311.

The introduction hole 422 may have an area smaller than the opening portion 412. For example, the introduction hole 422 may be constructed to have an area and a shape corresponding to the communication hole 4311.

The cover part 420 may include a seating surface 424 formed at the lower portion thereof, on which a seal is disposed to seal the opening portion 412. The seating surface 424 may seal the inner surface of the storage body 410 which is disposed lower than the opening portion 412, thereby offering an effect of sealing the opening portion 412. Accordingly, it is possible to more securely prevent leakage of water through the opening portion 412.

The cover part 420 may include installation grooves 426 formed in the two lateral sides of the cover body 421 in which the stoppers 450 are installed. The installation grooves 426 may be formed by depressing the two lateral surfaces of the cover body 421. Alternatively, the installation grooves 426 may be formed by projecting the inner surface of the introduction hole 422.

Each of the installation grooves 426 may be formed so as to receive at least a portion of the stopper 450. For example, the installation groove 426 may be formed to have such depth and volume as to receive the entire stopper 450.

The installation grooves 426 may be formed by depressing the two lateral surfaces of the cover body downwards from above. Each of the installation grooves 426 may have a width corresponding to the distance between the outer surface of the introduction hole 422 and the outer lateral surface of the cover body 421.

The cover part 420 may further include exposure holes 425 formed in the two lateral surfaces thereof, which are respectively connected to the installation grooves 426 so as to allow the stoppers 450 to be exposed to the outside.

The exposure holes 425 may be formed through two lateral surfaces of the cover body 421, and may expose the interior of the installation groove 426 to the outside of the cover body 421 or to the inner surface of the storage body 410.

When the stopper 450 is seated in the installation groove 426, the free end of the stopper 450 may project toward the outside of the exposure hole 425. Accordingly, the stopper 450 may be seated in the cover part 420 and be coupled to the storage body 410. The stopper 450 is capable of coupling the cover part 420 to the storage body 410.

The stopper 450 may include a pair of stoppers which are respectively disposed at the two lateral sides of the cover part 420. Consequently, even when one of the pair of stoppers 450 is separated from the storage body 410, the other stopper 450 may be maintained in the state of being coupled to the storage body 410, thereby preventing the cover part 420 from being unintentionally separated from the storage body 410.

The installation groove 426 and the exposure hole 425 may be disposed lower than the support surface 423 but higher than the seating surface 424. Accordingly, the stopper 450 may be coupled to the storage body 410 at a position lower than the opening portion 412. The stopper 450 is capable of stably coupling the cover part 420 to the storage body 410.

Furthermore, the stopper 450 may be disposed higher than the seal. Consequently, it is possible to prevent corrosion and contamination of the stopper 450 caused by contact between the water contained in the storage body 410 and the stopper 450.

In addition, when the storage body 410 includes the coupling hole 4111, it is also possible to prevent outflow of water through the coupling hole 4111.

The stopper 450 may be reciprocated in the installation groove 426 with respect to the exposure hole 425. The length of the stopper 450 may be set to be less than the width of the installation groove 426. The free end of the stopper 450 may be exposed through the exposure hole 425. Alternatively, the stopper 450 may be fully received in the installation groove 426 such that the free end of the stopper 450 is not exposed to the outside of the exposure hole 425.

As a result, the stopper 450 may be selectively coupled to the storage body 410, and the cover part 420 may be detachably coupled to the storage body 410.

The water storage 400 according to the present disclosure may include an elastic portion 460 configured to bias the stopper 450 toward the outside of the exposure hole 425. The elastic portion 460 may be supported at one end thereof by the installation groove 426 and may be fixed at the other end thereof to the stopper 450. The elastic portion 460 may be embodied as a spring.

The handle part 430 may be coupled to the upper portion of the cover part 420. The handle part 430 may include a main body 431 seated on the upper surface 4231, a support body 433 which extends downwards from the main body 431 and is seated on the stepped surface 4233, and a handle body 432 which extends from the main body 431 so as to be spaced apart from the support body 433.

The lower surface of the main body 431 and the lower surface of the support body 433 may be constructed so as to correspond to the shapes of the two lateral surfaces of the opening portion 412. However, the handle body 432 may be formed to have a shape different from the shape of the opening portion 412 and the shape of the cover part 420.

The handle body 432 and the support body 433 may extend forwards from the main body 431. The distance between the front end of the handle body 432 and the rear end of the main body 431 may be equal to the distance between the front end of the support body 433 and the rear end of the main body 431.

The free end of the handle body 432 and the free end of the main body 431 may be parallel to the front side of the storage body 411.

The main body 431 may have a length greater than the length of the handle body 432 and the length of the support body 433.

The handle body 432 and the support body 433 may extend from the main body 431 in a Y shape when viewed from lateral side.

The handle body 432 and the support body 433 may define the handle space H therebetween.

The stopper 450 may be disposed behind the support body 433.

When the handle part 430 is gripped and lifted by a user, the lower portion of the storage body 410 is subjected to force so as to be rotated forwards because the handle body 432 or the grip portion 440 is disposed in the front of the water storage 400. As a result, because the front lower portion of the storage body 410 is lifted and heightened, the front side of the storage body 410 may be subjected to greater force of gravity which causes the front side of the storage body 410 to be moved away from the handle body 432. Here, because the support body 433 extends forwards and downwards from the main body 433, the support body 433 may generate force which pushes the front side of the storage body 410 downwards. As a result, the support body 433 may cancel out the force which causes the lower portion of the storage body 410 to be lifted forwards, and thus it is possible to prevent the front side of the storage body 410 from being separated from the handle part 430.

Furthermore, the stopper 450 may be coupled to the storage body 410 at a position closer to the front side than to the rear side of the storage body 410.

As a result, by virtue of the structure of the handle part 430, even though the front upper portion of the water storage 400 is constructed so as to be gripped by a user, the water storage 400 may be stably moved, and may be easily detachably coupled to the attachment 380.

FIG. 15 illustrates a detailed example of the handle part 430.

Referring to FIG. 15(a), the grip portion 440 may be coupled to the front side of the handle 432. The lower surface of the grip portion 440 may be disposed closer to the support body 433 than the lower surface of the handle body 432.

The surface area of the grip portion 440 may be greater than the surface area of the front free end of the handle body 432.

The grip portion 440 may include a grip body 441 which is disposed in front of the handle body 432, and an insertion protrusion 442 which projects from the rear surface of the grip body 441 and is inserted into the handle body 432. The insertion protrusion 442 may be constructed to have a hook shape or the like.

The grip portion may further include a support protrusion 443 which projects from the grip body 441 at a level different from the level of the insertion protrusion 442. The support protrusion 443 may include a pair of support protrusions which are disposed at opposite sides based on the insertion protrusion 442.

Accordingly, even when the lower surface of the grip portion 440 is subjected to force so as to be rotated forwards, the support protrusion 443 and the insertion protrusion 442 may disperse the rotative force. Consequently, the grip portion 440 may be stably coupled to the handle part 430.

Referring to FIG. 15(b), the handle part 430 may include one or both of an insertion protrusion groove 4321 which is depressed at the front side of the handle body 432 and is coupled to the insertion protrusion 442, and support protrusion grooves 4322 which are disposed at opposite sides based on the insertion protrusion groove 4321 and are coupled to the support protrusions 433.

The handle part 430 may further include a catch protrusion 4323 which projects from the lower portion of the handle body 432 in the state of being spaced apart from the main body 431. Consequently, it is possible to increase the gripping force of the handle part 430.

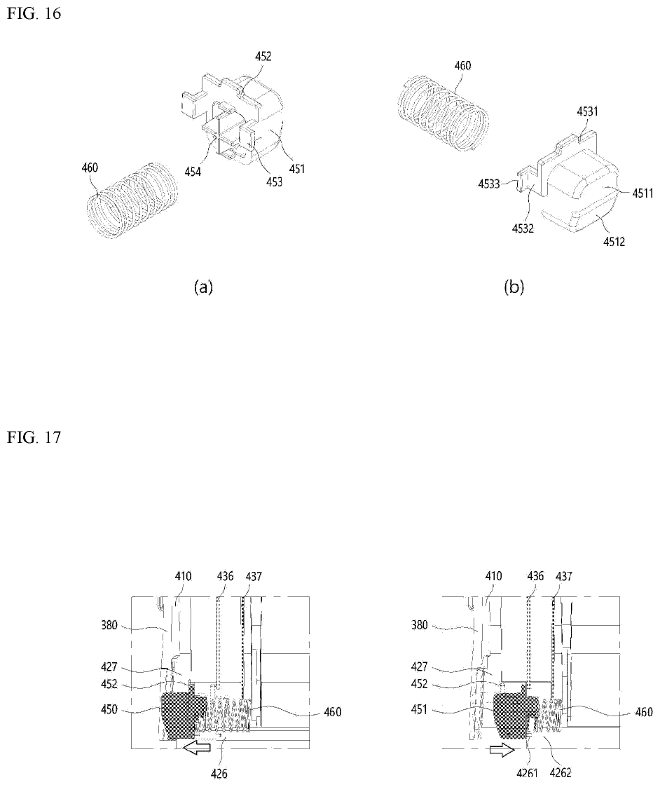

FIG. 16 illustrates an example of the stopper.

FIG. 16(a) illustrates the stopper 450 when viewed from the rear. FIG. 16(b) illustrates the stopper 450 when viewed from the front.

Because the stopper 450 is reciprocated in the installation groove 426, it is important to prevent warpage of the elastic portion 460. Specifically, if the elastic portion 460 pushes the stopper 450 or is compressed in a direction different from the direction in which the stopper 450 moves, the smooth reciprocating movement of the stopper 450 may be interrupted.

Here, if the stopper 450 include a guide column which is configured to support the entire elastic portion 460 disposed therein so as to guide compression and expansion of the elastic portion 460, the stopper 450 may be overly lengthened, and thus the width of the introduction hole 422 and the width of the communication hole 4311 may be excessively reduced.

Furthermore, when the water storage 400 is composed of a plurality of containers such as the water supply container and the water discharge container, the length of the stopper 450 may be increased, thereby causing a problem in that it is impossible to ensure sufficient areas of the introduction hole 422 and the communication hole 4311 which are formed in the water storage 400.

In order to solve the problem, the stopper 450 according to the present disclosure may include an elastic restoring portion coupled to the elastic portion 460. Here, the length of the elastic restoring portion may be less than the length of the elastic portion 460.

Because the stopper 450 according to the present disclosure is constructed to neither pass through the elastic portion 460 nor support the entire interior of the elastic portion 460, it is possible to reduce the length of the stopper 450. Accordingly, the water storage 400 according to the present disclosure is capable of reducing the volume or width of the installation groove 426 receiving the stopper 450, thereby ensuring a sufficient surface area or width of the introduction hole 422 or the communication hole 4311.

Specifically, the stopper 450 according to the present disclosure may include a fixing button 451 which projects through the exposure hole 425 and is coupled to the attachment 380 or the storage body 411, and an elastic fixing portion 453 which extends from the rear surface of the fixing button 451 and is supported by the elastic portion 460.

The length of the elastic fixing portion 453 may be less than the length of the elastic portion 460. For example, the length of the elastic fixing portion 453 may be less than the thickness of the fixing button 451.

The surface area of the elastic fixing portion 453 may be set to be smaller than the surface area of the elastic portion 460, and the surface area of the fixing button 451 may be set to be larger than the surface area of the elastic portion 460.

The elastic fixing portion 453 may be disposed in the elastic portion 460, and the fixing button 451 may be supported by one end of the elastic portion 460.

The stopper 450 may further include a restricting portion 452 which extends outwards from the outer surface of the fixing button 451. For example, the restricting portion 452 may be formed to have a plate shape which has a larger surface area than the fixing button 451.

The restricting portion 452 is capable of preventing the fixing button 451 from being overly inserted into the installation groove 426 or of preventing the entire stopper 450 from escaping to the outside of the exposure hole 425.

The stopper 450 may further include a movement guide 453 which extends from the fixing button 451 or the restricting portion 452 to guide reciprocating movement of the fixing button 451.

Because any of the cross-sectional area of the restricting portion 452 and the cross-sectional area of the movement guide 453 is larger than the cross-sectional area of the exposure hole 425, it is possible to prevent the stopper 450 from escaping from the exposure hole 425.

The movement of the restricting portion 452 and the movement guide 453 may be guided by components disposed in the installation groove 426, and thus the reciprocating movement of the fixing button 451 may be guided.

The movement guide 453 may include guide protrusions 4532 which extend from opposite sides of the fixing button 451 or the restricting portion 452, and extending ribs 4532 which further extend outwards from the guide protrusions 4532, respectively.

The guide protrusions 4532 may extend backwards from the fixing button 451 or the restricting portion 452, and the extending ribs 4532 may extend outwards from respective guide protrusions 4532. Accordingly, the fixing button 451 may project to the outside of the exposure hole 425 by a sufficient thickness.

The fixing button 451 may further include a fixing insertion surface 4511 which is detachably inserted into the attachment 380 or the storage body 410, and a fixing sloping surface 4512 which obliquely extends toward the fixing support from the fixing insertion surface.

The fixing sloping surface may extend from the lower portion of the fixing insertion surface 4512.

Accordingly, the fixing button 451 may be easily inserted into the storage body 410 and then into the coupling hole 4111.

The stopper 450 may serve both to close the opening portion of the storage body 410 and to couple the storage body 410 to the attachment 380. Consequently, the structure of the water storage 400 may be simplified, and the capacity of the water storage 400 may further be increased.

FIG. 17 illustrates the structure configured to support the stopper.

Because the stopper 450 is constructed such that the length of the elastic fixing portion is decreased, the installation groove 426, in which the stopper 450 and the elastic portion 460 are installed, may have reduced volume and width but there may be a difficulty in guiding linear reciprocating movement of the fixing button 451 or linear compression and expansion of the elastic portion 460.

To this end, the water storage 400 according to the present disclosure may be constructed such that movement or change of the stopper 450 or the elastic portion 460 is guided by components other than the stopper 450.

For example, the clothing treatment apparatus according to the present disclosure may be constructed such that the cover part 420 and the handle part 430 push or support at least one of the stopper 450 and the elastic portion 460. Both the cover part 420 and the handle part 430 may guide the regular movement of the stopper 450, and may guide regular compression and expansion of the elastic portion 460.

The cover part 420 and the handle part 430 may support at least one of the stopper 450 and the elastic portion 460 in an up-and-down direction to guide the regular movement of the stopper 450 and the elastic portion 460.

The cover part 420 may include the installation groove 426 configured to support the stopper 450 and the elastic portion 460. The installation groove 426 may be configured to support the lower portion of the stopper 450 and the lower portion of the elastic portion 460.

Furthermore, the installation groove 426 may also be configured to support opposite side surfaces of each of the stopper 450 and the elastic portion 460.

The installation groove 426 may include a button movement groove 4261 which extends from the exposure hole 425 to guide the reciprocating movement of the fixing button 451, and an elastic support groove 4261 which extends inwards from the button movement groove 4261 to support the elastic portion 460.

The installation groove 426 may be open at the upper side thereof. Accordingly, the handle part 430 may support at least one of the stopper 450 and the elastic portion 460 through the opening of the installation groove 426.

For example, the handle part 430 may further include a restricting protrusion 436 which extends into the installation groove 426 from the main body 431 so as to come into contact with the fixing button 451 or the restricting portion 452.

The restricting protrusion 436 may be configured to come into contact with the rear side of the fixing button 451 or the restricting portion 452, thereby preventing the fixing button 451 or the restricting portion 452 from being excessively inserted.

Alternatively, the restricting protrusion 436 may be configured to come into contact with the upper portion of the fixing button 451 or the restricting portion 452 and to have a certain thickness so as to serve as a rail for guiding the reciprocating movement of the fixing button 451 and the restricting portion 452.

The handle part 430 may include a fixing rib 437 which extends into the installation groove 426 from the main body 431 to come into contact with the elastic portion 460.

The fixing rib 437 may push the upper portion of the elastic portion 460 in order to prevent the elastic portion 460 from being separated from the installation groove 426 or the stopper 450 even when the elastic portion 460 is excessively pushed or vibrated.

Accordingly, the fixing rib 437 may maintain the position of the elastic portion 460 and may determine a direction in which the elastic portion 460 is compressed and expanded even when the stopper 450 does not hold the elastic portion 460.

The fixing rib 437 may be configured to push the elastic portion 460 toward the bottom surface of the elastic support groove 4262.

The fixing rib 437 may be positioned closer to the inside of the cover part 420 than the restricting protrusion 436 in the state of being spaced apart from the restricting protrusion 436, and may have a length greater than the restricting protrusion 436. Accordingly, the fixing rib 437 is capable of more effectively supporting the elastic portion 460.

The cover part 420 may further include a projection stopper 427 which is provided in the installation groove 426 and is disposed inside the exposure hole 425 so as to prevent removal of the stopper 450.

The projection stopper 427 may be constructed to have the form of a rib which extends inwards from the inner surface of the installation groove 426. The projection stopper 427 may be disposed outside the restricting protrusion 436, and may come into contact with the restricting portion 452.

Referring to FIG. 17(a), when external force is not applied to the stopper 450, the elastic portion 460 may be supported by the elastic support groove 4262, thereby pushing the stopper 450 out of the exposure hole 425. The elastic portion 460 may be supported at one end thereof by the inner surface of the installation groove 426 and be coupled at the other end thereof to the stopper 450.

As the fixing button 451 is pushed out of the exposure hole 425, the stopper 450 may pass through the storage body 410 and may then be coupled to the attachment 380.

Because the restricting portion 452 comes into contact with the projection stopper 427, it is possible to prevent the stopper 450 from escaping out of the exposure hole 425 by pressure applied thereto from the elastic portion 460.

Referring to FIG. 17(b), when the stopper 450 is pressed by external force, the elastic portion 460 may be compressed, and the stopper 450 may be inserted into the installation groove 426.

The stopper 450 may be separated from the storage body 410, and may also be separated from the attachment 380.

As the stopper 450 is further pressed, the restricting portion 452 may come into contact with the restricting protrusion 526. As a result, it is possible to prevent the fixing button 451 from being further inserted into the installation groove 426.

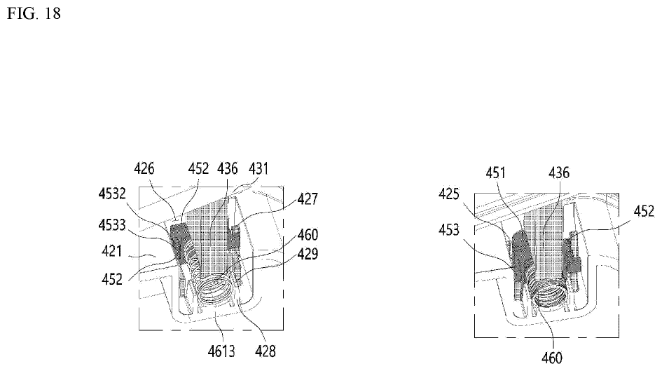

FIG. 18 illustrates an additional example in which the handle and the cover guide the stopper and the elastic portion.

Referring to FIG. 18(a), the cover part 420 may further include insertion stoppers 428 which are disposed on opposite surfaces of the distal end of the elastic portion 460.

Each of the insertion stoppers 428 may have a length such that the insertion stopper 428 comes into contact with the restricting portion 452 when the fixing button 451 is excessively pushed.

The projection stopper 427 may include a pair of projection stoppers which project from opposite sides of the inner surface of the installation groove 427 so as to come into contact with the restricting portion 452 or the movement guide 453.

A pair of guide rails 429 may be disposed at opposite sides of the elastic portion 460 in front of the insertion stopper 428 so as to support the movement guide 453.

The guide rails 429 may be disposed between the insertion stopper 428 and the projection stopper 427.

When the insertion stoppers 428 are provided, the restricting protrusion 426 may be provided at the lower end of a rail groove configured to guide reciprocating movement of the restricting portion 452 between the exposure hole 425 and the installation groove 426.

Although the insertion stopper 428 and the guide rail 429 may be disposed so as to be spaced apart from each other, they may be integrally formed.

Referring to FIG. 18(a), when the fixing button 451 is not pressed, the elastic portion 460 may push the fixing button 451 toward the exposure hole 425. Here, because the movement guide 453 comes into contact with the projection stopper 427, the movement guide 453 may be prevented from being separated out of the exposure hole 425.

Referring to FIG. 18(b), when the fixing button 451 is pressed, the elastic portion 460 may be compressed. When the fixing button 451 is sufficiently pressed, the rear surface of the restricting portion may come into contact with the insertion stopper 428, thereby preventing the stopper 450 from being further pressed. In addition, it is possible to prevent the elastic portion 460 from being excessively compressed.

At this time, the movement guide 453 may move toward the insertion stopper 428 while sliding along the upper end of the guide rail 429

The installation groove 426 may further include a support rib 4263 which is provided on the inner surface of the installation groove 426 and is in contact with the lower portion of the distal end of the elastic portion 460 to support the elastic portion 460.

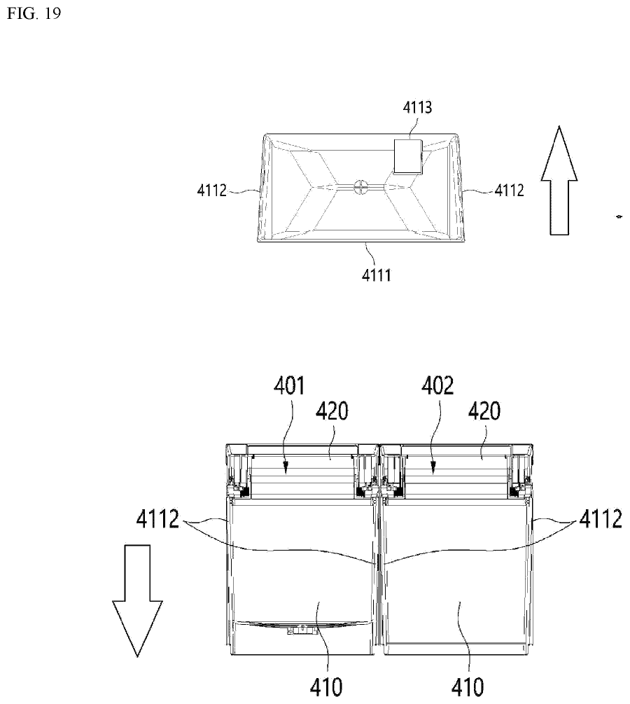

FIG. 19 illustrates an example of the shape of the storage body.

FIG. 19 is a view illustrating the storage body 410 when viewed from above.

The storage body 410 may include a front surface which is exposed to the outside when the storage body 410 is coupled to the attachment 380, two lateral surfaces 4112 which extend from lateral sides of the front surface 4111 and to which the stopper 450 may be coupled, and a rear surface 4113 which is opposed to front surface 4111 and which extends from the two lateral surfaces 4112.

The two lateral surfaces 4112 may be configured to be gradually narrowed moving toward the rear surface from the front surface. In other words, the two lateral surfaces 4112 may be configured such that the distance therebetween gradually decreases moving forwards from the rear.

Consequently, the width of the front surface 4111 may be set to be greater than the width of the rear surface 4113.

Accordingly, after a metal mold is inserted into the storage body 410 forwards from the rear and then injection molding is completed, the storage body 410 may be easily taken out. In addition, the storage body 410 may be easily inserted into the attachment 380 and stably seated on the attachment 380, and may be easily taken out.

Referring to FIG. 19(b), the two lateral surfaces 4112 may be configured to be gradually narrowed moving downwards from above. In other words, the two lateral surfaces 4112 may be configured such that the distance therebetween gradually decreases moving downwards from above.

The distance between the upper ends of the two lateral surfaces 4112 may be greater than the distance between the lower ends of the two lateral surfaces 4112.

Accordingly, after a metal mold is inserted into the storage body 410 downwards from above and then injection molding is completed, the storage body 410 may be easily taken out.

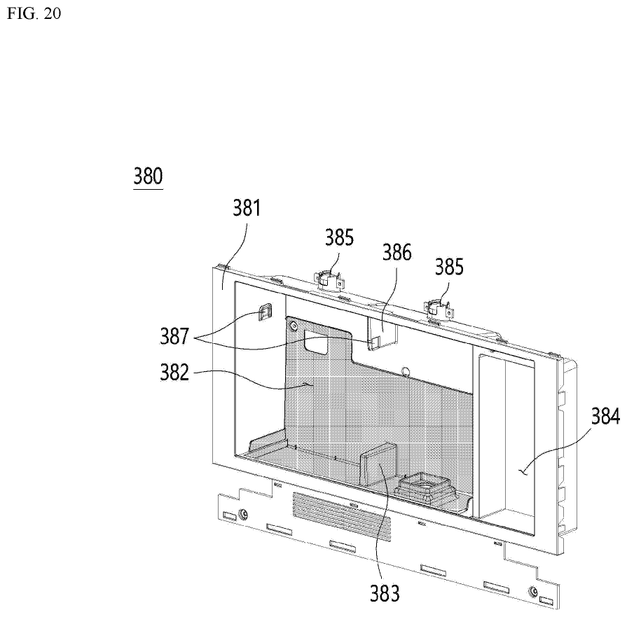

FIG. 20 illustrates an example of the attachment 380.

The attachment 380 may include the reception body 381 seated at the front side of the machine compartment 300, and the reception groove 382 which is depressed from the reception body 381 and in which the water storage 400 is seated.

The attachment 380 may further include a drawer hole 384 which is provided at one side of the reception groove 382 and in which the drawer 50 is inserted and taken out.

The attachment 380 may include at least one of a central coupler 383 which projects downwards from the upper surface of the reception groove 382, and the central separator 383 which projects upwards from the lower surface of the reception groove 382.

When the water storage 400 is composed of a plurality of containers such as the water supply container 401 and the water discharge container 402, the central coupler 383 or the central separator 383 may serve to support the containers in the state in which the containers are spaced apart from each other so as not to collide with each other.

The attachment 380 may include a coupling groove 387 to which the stopper 450 is detachably coupled. The coupling groove 387 may include a pair of coupling grooves which are disposed at the two lateral surfaces of the reception groove 382.

The central coupler 383 may extend in the reception groove 382 so as to face the stopper 450. Accordingly, the coupling groove 387 may also be provided in the opposite sides of the central coupler 383.

The coupling groove 387 may be constructed so as to receive the free end of the fixing button 451 by a certain depth. Accordingly, when the fixing button 451 is received, the fixing button 451 cannot be unintentionally separated from the coupling groove 387, and the water storage 400 may be easily seated on the attachment as long as no external force is applied to a user.

The attachment 380 may be embodied as a single injection-molded product, or may be integrally formed.

However, the attachment 380 may also be composed of two or more attachments which are assembled with each other depending on shape or function. For example, the attachment 380 may be composed of an attachment serving to receive the water storage and an attachment serving to receive water from the water storage or to discharge water to the water storage.

Accordingly, it is possible to separately manufacture a structure having complicated structure and function.

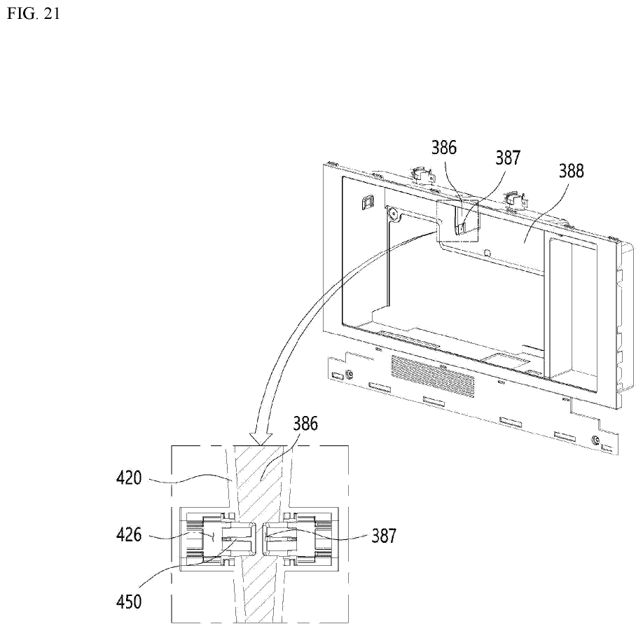

FIG. 21 illustrates an example of the coupling groove.

The coupling groove 387 may be constructed such that the depth thereof increases moving backwards from the front. The reason for this is to securely couple the fixing button 451 to the coupling groove, considering that the width of the storage body 410 decreases moving backwards from the front.

The central coupler 386 may support the water storage 400 in the state of being in surface contact with the water storage 400. Considering that the width of the storage body 410 decreases backwards from the front, the width or thickness of the central coupler 386 may increase moving backwards from the front.

Although not illustrated in the drawings, the central separator 383 may also be constructed such that the width or thickness thereof increases moving backwards from the front.

The slope of the opposite sides of each of the central coupler 386 and the central separator 383 may correspond to the slope of the opposite sides of the storage body 410.

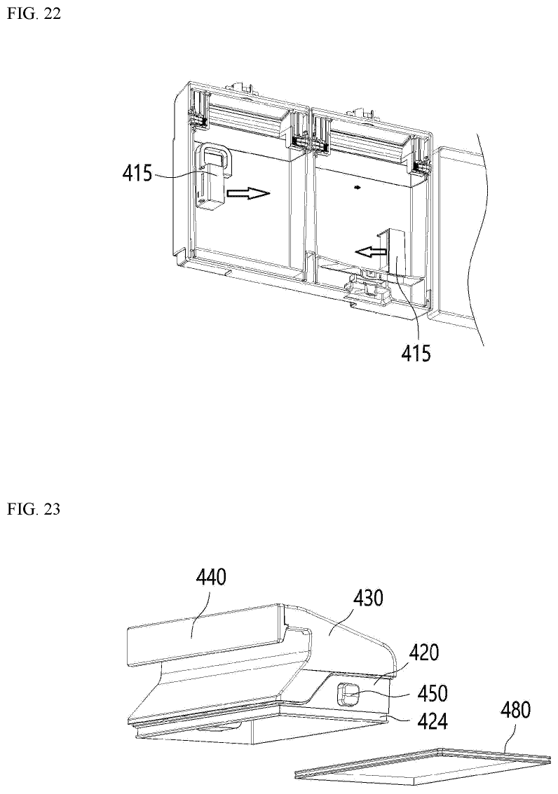

FIG. 22 illustrates the interior of the storage body.

The water storage 400 may include the sensor 470 configured to sense the water level therein.

The water storage 400 may include the water supply container 401 and the water discharge container. The sensor 470 of the water supply container 401 may sense a low water level, and the sensor 470 of the water discharge container 402 may sense a full water level.

To this end, the sensor case 415 of the water supply container 401 may be disposed closer to the lower end of the water supply container than to the upper end of the water supply container, and the sensor case 415 of the water discharge container 402 may be disposed closer to the upper end of the water discharge container than to the lower end of the water discharge container.

The sensor case 415 may be easily manufactured integrally with the storage body 410.

The sensor case 415 may be constructed to have the form of a box which has an insertion opening at one surface thereof to receive the sensor 470 therein. Accordingly, the sensor case 415 may be manufactured integrally with the storage body 410 by means of an L-shaped metal mold configured to form the insertion opening, through injection molding.

Furthermore, the water storage 400 may be constructed in such a way as to manufacture the water supply container 401 and the water discharge container 402 together.

In addition, the sensor case 415 installed at the water supply container 401 and the sensor case 415 installed at the water discharge container 402 may also be manufactured together.

Accordingly, in order to easily install a metal mold configured to form the insertion opening and to remove the metal mold at one time, the insertion opening of the water supply container 401 and the insertion opening of the water discharge container 402 may be oriented so as to face each other. The insertion opening of the water supply container 401 and the insertion opening of the water discharge container 402 may be oriented so as to face inwards.

When the insertion opening of the water supply container 401 and the insertion opening of the water discharge container 402 are spaced apart from each other as far as possible, it is easy to remove the metal mold.

Accordingly, the insertion opening of the water supply container 401 may be disposed closer to one lateral surface of the water supply container 401 than to the other lateral surface of the water supply container 401. Furthermore, the insertion opening of the water discharge container 401 may be disposed closer to one lateral surface of the water discharge container 402 than to the other lateral surface of the water discharge container 402.

The insertion opening of the water supply container 401 may be disposed closer to the lateral surface of the storage body 410 of the water supply container 401 that is farthest from the water discharge container 402 than to the lateral surface of the storage body 410 of the water supply container 401 that faces the storage body 410 of the water discharge container 402.

The insertion opening of the water discharge container 402 may be disposed closer to the lateral surface of the storage body 410 of the water discharge container 402 that is farthest from the water supply container 402 than to the lateral surface of the storage body 410 of the water discharge container 402 that faces the storage body 410 of the water supply container 401.

FIG. 23 illustrates a sealing structure of the water storage.

The water storage 400 may further include a sealing portion 480 which is coupled to the cover part 420 so as to seal the storage body 410.

The sealing portion 480 may be constructed to have the form of a ring coupled to the periphery of the seating surface 424 of the cover part 420 so as to contact the inner surface of the storage body 410.

The sealing portion 480 may be disposed lower than the stopper 450. Therefore, it is possible to prevent the water contained in the storage body 410 from flowing into the installation groove 426.

When the cover part 420 is coupled to the storage body 410, the sealing portion 480 may be disposed lower than the opening portion 412.

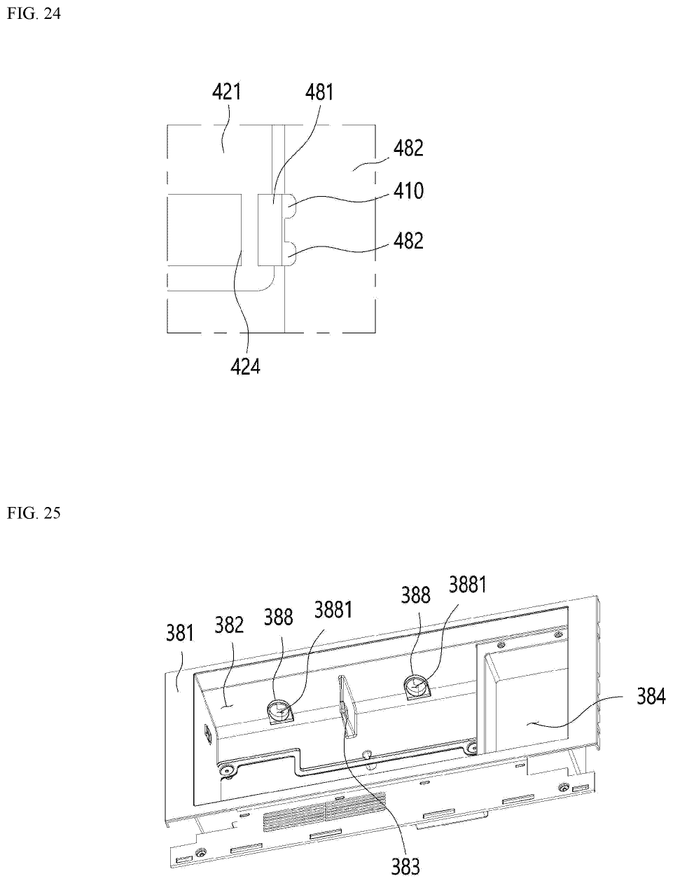

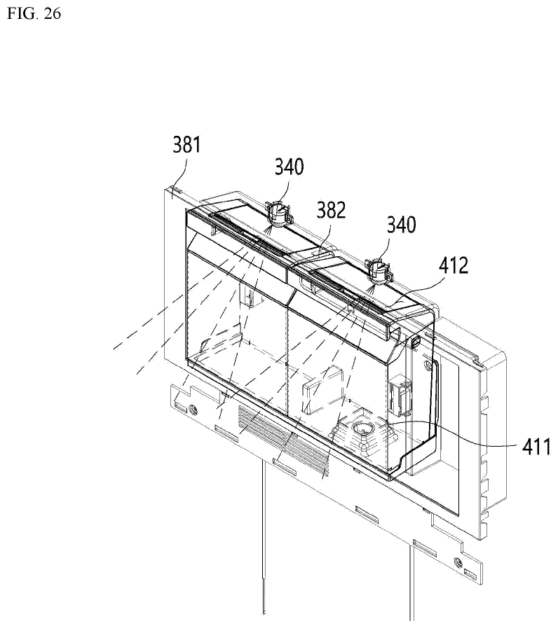

FIG. 24 illustrates the detailed structure of the sealing portion.

The sealing portion may include a sealing body 481 coupled to the periphery of the seating surface 424, and a contact ring 482 which projects from the sealing body 481 to come into contact with the inner surface of the storage body 410.

The contact ring 482 may include a plurality of contact rings which are spaced apart from each other in an up-and-down direction or in the thickness direction of the sealing body 481. Consequently, the sealing portion 480 is capable of maximizing a sealing effect by intensively pressing the inner surface of the storage body 410 and increasing the contact area.

The sealing portion 480 may seal a portion of the storage body 410 which is positioned lower than the opening portion 412 or the step of the upper surface of the storage body 410. Therefore, the sealing portion 480 is capable of sealing the storage body 410, regardless of the shape of the upper end of the storage body 410.

FIG. 25 illustrates an additional example of the attachment.

The clothing treatment apparatus according to the present disclosure may further include an illuminator 390 which is provided at the attachment 380 so as to radiate light to the water storage 400. The illuminator 390 may be embodied as any of a filament bulb, an LED and the like as long as the illuminator radiates light.

The attachment 380 may further include an illuminator installation portion 388 to which the illuminator 390 is mounted or installed.

The illuminator installation portion 388 may include a socket to which the illuminator 390 is mounted, and an illumination hole 3881 which is formed through the reception surface 382 such that the socket is exposed through the illumination hole 3881.

Therefore, it is possible to prevent the light radiated from the illuminator 390 from being shielded by the attachment 380.

The illuminator installation portion 388 may be disposed in the reception groove 382 higher than the storage body 410. Consequently, it is possible to prevent water from entering the illuminator installation portion 388.

The illuminator installation portion 388 may be disposed closer to the rear side of the reception groove 382 than to the front side of the reception groove 382. Therefore, it is possible to minimize influence of the water storage 400 on the illuminator 390 while the water storage 400 is mounted and removed. Furthermore, the light radiated from the illuminator 390 may be intensively guided forwards and may be transmitted to a user.

The illuminator 390 may be configured to radiate light when the inner case 200 is opened by the door 120. Therefore, the user is able to intuitively recognize presence of the water storage 400 and the amount of the water contained in the water storage 400 by virtue of the light radiated from the illuminator 390.

The illuminator 390 may be installed at the illuminator installation portion 358 so as to radiate light to the water storage 400 from a position higher than the water storage 400.

The illuminator 390 may be provided at each of regions corresponding to the water supply container 401 and the water discharge container 402.

The illuminator 390 may be configured to radiate light to the handle part 430 and the cover part 420. The cover door 455 coupled to the handle part 430 may be made of a translucent or transparent material such that the light radiated from the illuminator 390 passes through the opening portion 412.

Furthermore, the storage body 410 may also be made of a material which allows at least a portion of the light to be transmitted therethrough. The storage body 410 may also be made of a translucent or transparent material.

The illuminator 390 may be disposed at the rearmost position on the upper surface of the reception surface 382.

For example, the illuminator 390 may be disposed at a corner at which the upper portion of the reception surface 382 meets the rear surface of the reception surface 382.

Consequently, most of the light radiated from the illuminator 390 may pass through the storage body 410 and may be transmitted to a user who is positioned in front of the clothing treatment apparatus.

At least a portion of the illuminator 390 may be disposed so as to overlap the cover door 355 or the opening portion 412 in an up-and-down direction.

The illuminator 390 may be disposed in the communication hole 4311 and the introduction hole 422 when viewed in an up-and-down direction. Therefore, it is possible to maximally prevent occurrence of a shadow caused by the handle part 430 and the cover part 420.

The light radiated from the illuminator 300 may be transmitted through the water contained in the storage body 410 and air at different angles, thereby accurately providing a user with information about water level.

It will be apparent to those skilled in the art that various modifications and variations can be made in the present disclosure without departing from the spirit or scope of the present disclosure. Thus, it is intended that the present disclosure covers the modifications and variations of this present disclosure provided they come within the scope of the appended claims and their equivalents.

What is claimed is:

1. A clothing treatment apparatus clothing treatment apparatus comprising:
a cabinet having an opening at a front surface thereof;
an inner case provided in the cabinet and defining an accommodation space configured to receive laundry;
a machine compartment disposed lower than the inner case so as to supply at least one of hot air and steam to an inside of the inner case;
a door rotatably coupled to the cabinet so as to close at least one of the inner case and the machine compartment; and
at least one water storage detachably provided in front of the machine compartment so as to supply water for generation of steam or to collect water condensed in the machine compartment,
wherein the water storage comprises:
a storage body comprising an opening portion at an upper portion thereof and receiving water therein; and
a cover part detachably coupled to the storage body so as to close the opening portion, and
wherein a cross-sectional area of the opening portion corresponds to a cross-sectional area of the storage body.

2. The clothing treatment apparatus of claim 1, wherein the opening portion is configured to open an entire upper portion of the storage body, and the cover is configured to entirely close the opening portion.

3. The clothing treatment apparatus of claim 1, wherein the cover part comprises:
a cover body introduced into the opening portion and detachably coupled to an inner surface of the storage body; and
an introduction hole formed through the cover body so as to communicate with an inside of the storage body.

4. The clothing treatment apparatus of claim 3, wherein the water storage further comprises a seal portion coupled to the cover body along a periphery of the cover body so as to come into contact with an inner surface of the storage body.

5. The clothing treatment apparatus of claim 4, wherein the water storage comprises a stopper which projects from the cover body and is detachably coupled to the storage body, and
wherein the stopper is disposed higher than the seal portion.

6. The clothing treatment apparatus of claim 5, wherein the stopper comprises a pair of stoppers which are inserted into the cover body from two lateral sides of the cover body so as to be able to be separated from the storage body.

7. The clothing treatment apparatus of claim 5, further comprising a handle part coupled to an upper portion of the cover so as to close the introduction hole.

8. The clothing treatment apparatus of claim 7, wherein the handle part comprises:
a main body seated on an upper portion of the cover body;
a handle body projecting forwards from a front and upper portion of the main body; and
a support body obliquely extending from a front and lower portion of the main body.

9. The clothing treatment apparatus of claim 8, wherein the support body is disposed in front of the stopper.

10. The clothing treatment apparatus of claim 8, wherein the handle part further comprises a grip portion coupled to a front side of the handle body and projecting downwards beyond the handle body.

11. The clothing treatment apparatus of claim 8, wherein the handle part further comprises:
a communication hole formed through an upper portion of the handle body so as to communicate with the opening portion; and
a cover door rotatably coupled to the upper portion of the handle body so as to close the communication hole.

12. The clothing treatment apparatus of claim 11, wherein the communication hole is formed through an upper portion of the handle part from a portion behind the stopper to a portion ahead of the stopper, and
wherein the cover door is coupled to a portion of the handle body behind the stopper in such a manner as to be rotated upwards so as to selectively open the communication hole.

13. The clothing treatment apparatus of claim 8, wherein the storage body comprises:
open surfaces provided at upper portions of two lateral surfaces of the storage body so as to face the main body; and
sloped surfaces which extend downwards from front sides of the open surfaces to face the support body.

14. The clothing treatment apparatus of claim 13, wherein the storage body further comprises coupling holes which are formed through two lateral sides of the storage body and into which the stoppers are inserted, and
wherein the coupling holes are disposed behind the sloped surface.

15. The clothing treatment apparatus of claim 1, wherein the storage body is made of a translucent or transparent material.
